(19) United States
(12) Patent Application Publication
(10) Pub. No.: US 2017/0206717 A1
(43) Pub. Date: Jul. 20, 2017

(54) SYSTEM AND METHOD FOR DRIVER EVALUATION, RATING, AND SKILLS IMPROVEMENT

(71) Applicant: Trendfire Technologies, Inc., Auburn, CA (US)

(72) Inventor: Ralf Kühnapfel, Böblingen (DE)

(21) Appl. No.: 15/000,160

(22) Filed: Jan. 19, 2016

(51) Int. Cl. G07C 5/00; G06F 17/30; G09B 19/14; H04L 29/06; G09B 19/16; G06Q 40/08; H04L 29/08

(52) U.S. Cl. CPC G07C 5/008; G06Q 40/08; G06F 17/30979; H04L 67/12; H04L 67/42; G09B 19/167; G09B 19/14

(57) ABSTRACT

Systems and methods for driver evaluation, rating, and skills improvement are disclosed. A particular embodiment is configured to: receive vehicle data from vehicle subsystems of a vehicle via a vehicle subsystem interface; correlate the vehicle data to a corresponding set of preprocessing events representing activity or state transitions occurring in the vehicle; aggregate the set of preprocessing events into a plurality of data blocks, wherein each data block corresponds to a user-configurable time frame; and transfer the plurality of data blocks to a central server via a network interface and a network.

### COPYRIGHT NOTICE

A portion of the disclosure of this patent document contains material that is subject to copyright protection. The copyright owner has no objection to the facsimile reproduction by anyone of the patent document or the patent disclosure, as it appears in the U.S. Patent and Trademark Office patent files or records, but otherwise reserves all copyright rights whatsoever. The following notice applies to the disclosure herein and to the drawings that form a part of this document: Copyright 2015-2016, Trendfire Technologies Inc., All Rights Reserved.

### TECHNICAL FIELD

This patent document pertains generally to apparatus, systems, and methods for vehicle driver evaluation, rating, and skills improvement.

### BACKGROUND

Modern vehicles are equipped with one or more independent computer and electronic data processing systems. Certain of the processing systems are provided for vehicle operation or efficiency. For example, most vehicles are equipped with various vehicle electronic control systems for monitoring and controlling engine parameters, brake systems, speed, acceleration, driver control systems, fuel level, tire pressure, and other vehicle operating characteristics and systems. The vehicle operational parameters generated by the various vehicle electronic control systems can be used to assess the behavior, efficiency, and safety of the vehicle and the vehicle driver.

Driver skill and responsible driving behavior is critical for vehicle safety and efficiency. Various methods and systems have been proposed for automatically monitoring a driver and the manner in which the vehicle is being driven. Such systems and methods allow objective driver evaluation to determine the quality of the driver's driving practices and facilitate the collection of qualitative and quantitative information related to the operation of the vehicle. These systems and methods help to prevent or reduce inefficient or unsafe use of the vehicle, vehicle accidents, and vehicle abuse, and also help to reduce vehicle operating, maintenance, and replacement costs. The economic value of these systems is especially significant for commercial and institutional vehicle fleets.

Driver monitoring and scoring systems vary in their features and functionality and exhibit considerable variability in their approach to the overall problem. Some solutions focus on location and logistics, others on engine diagnostics and fuel consumption, others on insurance considerations, and others concentrate on safety management or accident forensics.

For example, U.S. Pat. No. 5,546,305 to Kondo performs an analysis of vehicle speed and acceleration, engine rotation rate, and applies threshold tests. Such an analysis can often distinguish between good driving behavior and erratic or dangerous driving behavior (via a driving “roughness” analysis). Providing a count of the number of times a driver exceeded a predetermined speed threshold, for example, may be indicative of unsafe driving.

U.S. Pat. No. 6,438,472 to Tano, et al. describes a system, which statistically analyzes driving data (such as speed and acceleration data) to obtain statistical aggregates that are used to evaluate driver performance. Unsatisfactory driver behavior is determined when certain predefined threshold values are exceeded. A driver whose behavior exceeds a statistical threshold from what is considered safe driving, is classified as a “dangerous” driver. Thresholds can be applied to the statistical measures, such as standard deviation.

U.S. Pat. Publ. No. 20130345927 to Cook describes a driver risk assessment system and method having calibrated automatic event scoring. The system and method provide event scoring and reporting, while also optimizing data transmission bandwidth. The system includes onboard vehicular driving event detectors that record data related to detected driving events and selectively store or transfer data related to the detected driving events. If elected, the onboard vehicular system will score a detected driving event, compare the local score to historical values previously stored within the onboard system, and upload selective data or data types to a remote server or user if the system concludes that a serious driving event has occurred. Importantly, the onboard event scoring system, if enabled, will continuously evolve and improve in its reliability by being periodically re-calibrated with the ongoing reliability results of manual human review of automated predictive event reports. The system may further respond to independent user requests by transferring select data to said user at a variety of locations and formats.

However, existing driver monitoring and scoring systems have proven to be: 1) too rigid in their implementations by failing to provide robust parameter and scoring customization; 2) too isolated or narrow in focus by failing to enable broad driver score normalization; 3) failing to provide score cross-comparisons between drivers, vehicles, fleets, companies, and industries; and 4) unable to consider route difficulty in the driver scoring and normalization.

### BRIEF DESCRIPTION OF THE DRAWINGS

The various embodiments are illustrated by way of example, and not by way of limitation, in the figures of the accompanying drawings in which:

FIG. 1 illustrates a block diagram of an example modular in-vehicle telematics unit architecture with a telematics unit and network system in which embodiments described herein may be implemented;

FIG. 2 illustrates a block diagram of another example modular in-vehicle telematics unit architecture with a telematics unit and network system in which embodiments described herein may be implemented;

FIG. 3 illustrates the components of the telematics unit of an example embodiment;

FIG. 4 illustrates an example embodiment of a processing flow showing an overview of the vehicle data flow from the vehicle subsystems to one or more of the data consumers or consumer nodes (e.g., the central server, a network client, a mobile device application, and/or a network resource);

FIG. 5 illustrates an example embodiment of a processing flow showing data processing performed by the telematics unit for receiving, converting, filtering, and aggregating the processed vehicle data into configurable data blocks;

FIG. 6 illustrates an example embodiment of a system architecture showing data processing performed by the telematics unit for receiving, converting, filtering, and aggregating the processed vehicle data into configurable data blocks;

FIG. 7 illustrates an example embodiment of a system architecture showing data processing performed by the telematics unit and the central server for aggregating the processed vehicle data into configurable data blocks and summaries;

FIG. 8 illustrates an example embodiment of a system architecture showing data processing performed by the central server for calculating degree of trip difficulty values and raw driver score values from the configurable data blocks and vehicle/driver summaries and for delivering the final rating information to one or more of the client devices (e.g., a network client, a mobile device app, and/or a network resource);

FIG. 9 is a graph illustrating an association between the Degree of Trip Difficulty (DTD) and the corresponding bonus value for a particular driver in an example embodiment;

FIGS. 10 through 17 illustrate example user interface screen snapshots, implemented as a web application, that show the basic elements of the user interface for displaying data associated with the evaluation, rating, and skills improvement for a particular driver, in a particular vehicle, and on a particular date in an example embodiment;

FIG. 18 illustrates an example user interface screen snapshot, implemented as a web application, that shows the basic elements of the user interface for displaying data associated with the evaluation, rating, and skills improvement for a particular driver, in a particular vehicle, and on a particular date in an example embodiment, particularly, illustrating an example of a Fleet Productivity Index (FPI): Cross Company Comparison chart;

FIG. 19 illustrates an example user interface screen snapshot, implemented as a mobile device application, that shows the basic elements of the user interface for displaying data associated with the evaluation, rating, and skills improvement for a particular driver, in a particular vehicle, and on a particular date in an example embodiment, particularly, illustrating an example of a Driver Ranking view for a particular time period;

FIGS. 20 and 21 are processing flow charts illustrating example embodiments of systems and methods for driver evaluation, rating, and skills improvement; and

FIG. 22 shows a diagrammatic representation of machine in the example form of a computer system within which a set of instructions when executed may cause the machine to perform any one or more of the methodologies discussed herein.

### DETAILED DESCRIPTION

In the following description, for purposes of explanation, numerous specific details are set forth in order to provide a thorough understanding of the various embodiments. It will be evident, however, to one of ordinary skill in the art that the various embodiments may be practiced without these specific details.

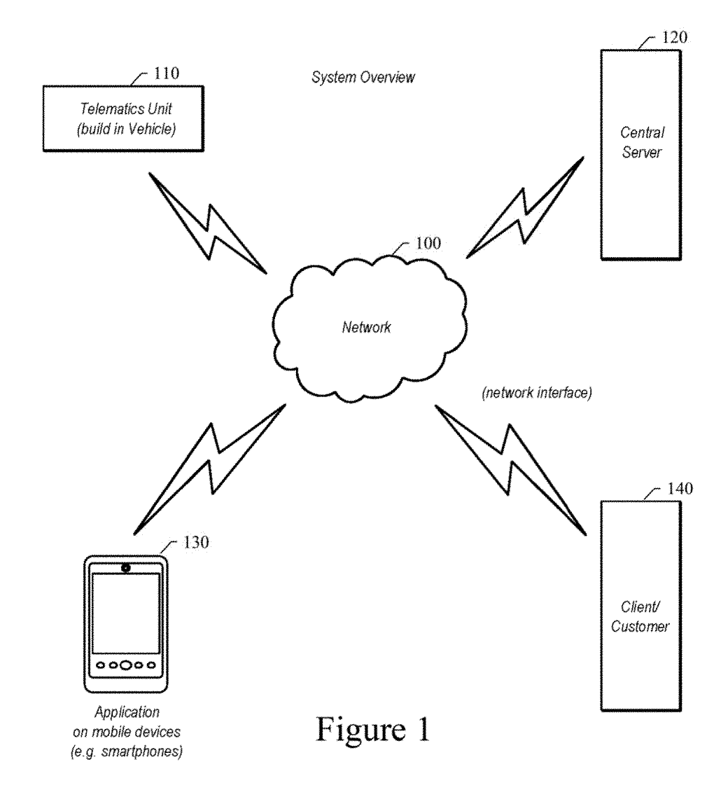

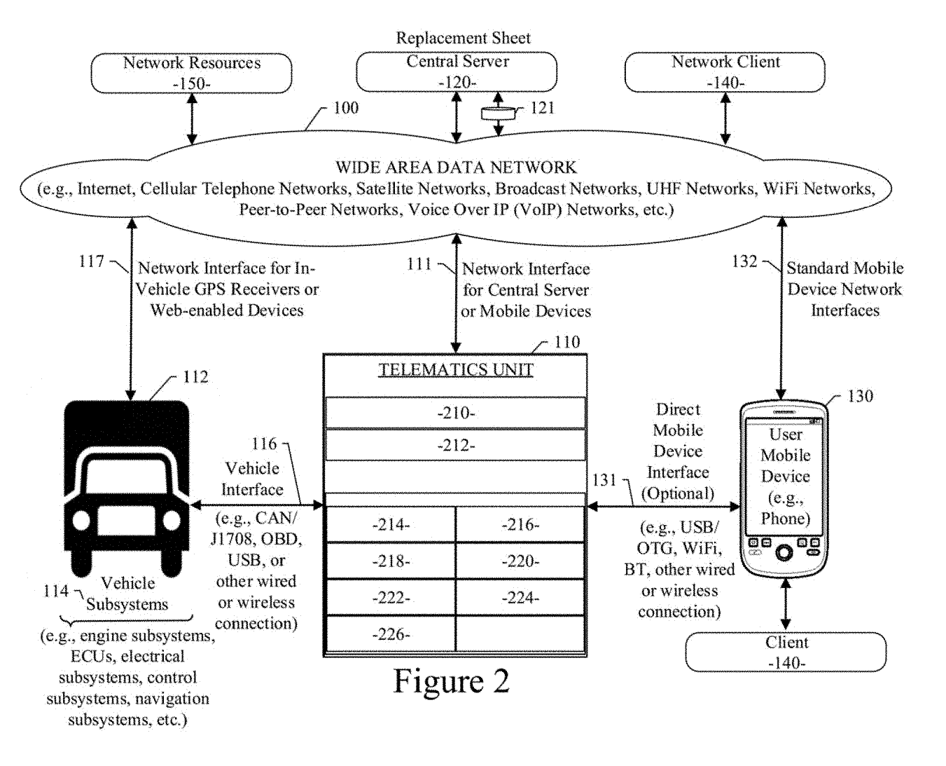

As described in various example embodiments, systems and methods for driver evaluation, rating, and skills improvement are described herein. In one example embodiment, a modular in-vehicle telematics unit architecture can be configured like the architecture illustrated in FIG. 1. In another example embodiment, a modular in-vehicle telematics unit architecture can be configured like the architecture illustrated in FIG. 2. However, it will be apparent to those of ordinary skill in the art that the driver evaluation, rating, and skills improvement system as described herein can be implemented, configured, and used in a variety of other applications, ecosystems, and system architectures.

Particular example embodiments relate to a modular telematics hardware architecture, wherein traditional vehicle subsystems, such as engine subsystems, electrical subsystems, control subsystems, navigation subsystems, and vehicle-resident external network interfaces can be accessed by an in-vehicle telematics unit directly or via a Controller Area Network (CAN) bus or J1708 interface. In one example embodiment, the telematics unit can run an operating system and processing logic to control the operation of the telematics unit. The telematics unit can further include a variety of vehicle subsystem interfaces, data/device interfaces, and network interfaces, such as a CAN/J1708 interface, a wireless data transceiver interface, a driver identification interface, a global positioning system (GPS) module, and optionally a direct mobile device interface. In example embodiments, the in-vehicle telematics unit can gather a variety of vehicle operational parameters, including vehicle data and control signals from the various vehicle subsystems, which are associated with the operation of a particular vehicle, a particular driver, and a particular timeframe. The telematics unit can aggregate the vehicle operational parameters into a plurality of data blocks, which can be transferred via a network interface and a wide area data network to a central server for further processing. Users, customers, or clients can access the processed vehicle and driver data via the wide area data network using web-enabled devices or mobile devices.

As described in more detail below, the in-vehicle telematics unit and the central server in an example embodiment operate in concert to provide a vehicle driver analysis system configured to rate driver behavior based on the real-time vehicle operational parameters captured from vehicle subsystems. In particular, the vehicle driver analysis system can be configured to provide an accurate, unbiased method of collecting, measuring, logging, analyzing, summarizing, and reporting key parameters of driver behavior in a way that allows rating and improvement of driver styles and skills, fair and unbiased comparison of drivers regardless of differences in type of equipment driven or route characteristics, and prioritization of the importance of the measured driving parameters by business managers. The details of various example embodiments are provided below.

FIG. 1 illustrates a block diagram of an example modular in-vehicle telematics unit architecture with a telematics unit 110 and network system in which embodiments described herein may be implemented. Example embodiments relate to a vehicle-resident telematics unit 110 in networked data communication with a central server 120 and mobile devices 130 via the wide area data network 100, such as the Internet, the cellular telephone networks, satellite networks, UHF networks, broadcast networks, WiFi networks, peer-to-peer networks, Voice Over IP (VoIP) networks, and the like. Users, customers, or clients 140 can be in data communication with the telematics unit 110 and the central server 120 via the wide area data network 100 using web-enabled devices, personal computers, mobile devices 130, or the like. Embodiments disclosed herein generally provide the telematics unit 110 to enable the communication and control of data signals, information, and services between in-vehicle subsystems of a vehicle, including electronic control units (ECUs) of the vehicle, and network-based nodes, such as the central server 120, mobile devices 130 (e.g., mobile phones or mobile computing platforms), and users, customers, or clients 140 via the wide area data network 100. In addition, other network-based nodes can include network resources, such as server computers, websites, networked databases, distributed systems, and the like. These network-based nodes, such as nodes 120, 130, and 140, can be accessible to the telematics unit 110 via a conventional wide area data network 100.

FIG. 2 illustrates a block diagram of another example modular in-vehicle telematics unit architecture with a telematics unit 110 and network system in which embodiments described herein may be implemented. The example embodiment shown in FIG. 2 includes the vehicle-resident telematics unit 110 in networked data communication with the central server 120, users, customers, or clients 140, mobile devices 130, and network resources 150 via the wide area data network 100. The central server 120 can also be in direct data communication with a local database or datastore 121 or in network connection with a cloud-based datastore 121. FIG. 2 also shows the vehicle 112 in which the telematics unit 110 can be installed, placed, or integrated. In the example embodiment, the telematics unit 110 can be connected with a vehicle interface 116, (e.g., a CAN bus interface, J1708 interface, or the like) in the vehicle 112 via a detachable connector (e.g., a J1708 interface connector, an On Board Diagnostic (OBD) connector, a Universal Serial Bus (USB) connector, or other standard wired connection). In a particular embodiment, a J1708 interface connection apparatus can be used. The conventional SAE International™ J1708 specification defines a differential serial communications bus for inter-connecting ECUs on heavy-duty and commercial vehicles. This conventional specification does this by standardizing a hardware and software protocol for sending messages as data outside of the vehicle 112 via vehicle interface 116. The telematics unit 110 can be configured to receive this data from vehicle subsystems 114 via the J1708 interface connection. In other embodiments or other vehicles, the telematics unit 110 can be attached to or integrated with the CAN bus or a J1708 interface in the vehicle 112 via a standard type of wireless data connection. Once the telematics unit 110 is in data communication with the vehicle 112 via the wired or wireless vehicle interface 116, the telematics unit 110 can obtain access to data, information, and control signals generated by the various vehicle subsystems 114 of vehicle 112, including engine subsystems, ECUs, electrical subsystems, control subsystems, navigation subsystems, and/or the like. Many modern vehicles also have a built-in interfaces 117 to directly access the wide area data network 100. For example, in-vehicle navigation subsystems can use these network resources for vehicle navigation. In other cases, some vehicles include web-enabled devices or cellular-enabled devices, which can communicate with network resources 150 or other network nodes via network interface 117 and network 100. Network resources 150 can include server computers, websites, networked databases, distributed systems, and the like. Once the telematics unit 110 is in data communication with the vehicle 112 via the wired or wireless vehicle interface 116, the telematics unit 110 can obtain access to data and information at the network resources 150 via network interface 117 and network 100. Alternatively, the telematics unit 110 can directly access the network 100 via a standard wireless network connection 111. In this manner, the telematics unit 110 can access the central server 120 and network clients 140 via network interface 111 and network 100. The telematics unit 110 can also use network interface 111 and network 100 to establish data communication with users, customers, or clients using mobile devices 130, and the application (apps) installed therein. Mobile devices 130 and mobile device apps can communicate with network resources 150, central server 120, and network clients 140 using a standard mobile device network interface 132 and network 100. As such, the telematics unit 110 has a robust set of network interfaces to establish data communication with network resources 150, central server 120, network clients 140, and apps in mobile devices 130. Thus, users, customers, or clients 140 can be in data communication with the telematics unit 110 and the central server 120 via the wide area data network 100 using web-enabled devices, personal computers, mobile devices 130, or the like. In addition, the telematics unit 110 can be in direct data communication with the vehicle 112 via the vehicle interface 116 as described above.

In a particular embodiment, the telematics unit 110 can also be configured for direct communication with a mobile device 130 via a direct mobile device interface 131. In some circumstances, such as when network connectivity is not available or reliable, an embodiment provides direct mobile device interface 131 to directly connect the mobile device 130, and an app executing therein, to the telematics unit 110. In this manner, driving feedback can be accessed by the driver in real-time without the need for network access or without incurring delays in the network access. The direct mobile device interface 131 can be implemented using a standard USB or USB/OTG (On-The-Go) interface or other standard wired connection. Alternatively, the direct mobile device interface 131 can be implemented using a standard wireless data communication interface, such as WiFi, Bluetooth™ (BT), or the like. Well-known technologies exist for pairing a mobile device 130 with in-vehicle electronics for data communication. Thus, users, customers, or clients 140 can be in direct data communication with the telematics unit 110 via mobile device 130, and an app executing therein, even if connectivity with network 100 is not available or reliable. Additionally, when network connectivity is not available or reliable, an embodiment of the telematics unit 110 provides a caching function to cache data staged for transfer via the network 100 until network connectivity is restored.

Generally, FIGS. 1 and 2 depict the interfaces for communication of data, information, and signals (denoted herein as the vehicle data) between (from/to) the vehicle subsystems 114 and the telematics unit 110, the central server 120, and the mobile device(s) 130. Some of the vehicle data can be produced at the vehicle subsystems 114. Others of the vehicle data can be sourced from a network node via network 100 and received at the vehicle subsystems 114. The format and content of the vehicle data received by the telematics unit 110 via vehicle interface 116 can be converted, filtered, processed, aggregated, stored, and forwarded by the telematics unit 110. This vehicle data processing, aggregation, and forwarding performed by the telematics unit 110 is described in more detail below. The vehicle data can be further processed at the central server 120 after being transferred from the telematics unit 110 via network interface 111 and network 100. For example, vehicle data communicated from the vehicle subsystems or the ECUs of the vehicle 112 (e.g., vehicle subsystems 114) to the telematics unit 110 may include information about the state of one or more of the components or control systems of the vehicle 112. Thus, the vehicle data can be indicative of various events or state transitions occurring in the vehicle 112. The vehicle data, which can be communicated from the vehicle subsystems 114 of the vehicle 112, can be received and processed by the telematics unit 110 and the central server 120, or processed solely by the telematics unit 110.

FIGS. 1 and 2 depict systems that include a vehicle 112 with various vehicle subsystems 114. The systems and methods described herein can be used with substantially any mechanized system that uses a CAN bus, a J1708 interface, or other vehicle subsystem interfaces as described herein, including, but not limited to, industrial equipment, boats, trucks, or automobiles; thus, the term “vehicle” extends to any such mechanized systems. The systems and methods described herein can also be used with any systems employing some form of network data communications.

In an example embodiment, the in-vehicle telematics unit 110 can be integrated into the electronics or control systems of the vehicle 112 or physically separate from other vehicle components and attached to the vehicle subsystems 114 via a detachable connector, which allows the telematics unit 110 to be easily installed or exchanged as vehicle or device technologies change or improve. As described above, the telematics unit 110 can connect to the various vehicle subsystems 114 and/or the CAN bus/J1708 interface via a detachable connector with an electromechanical design. Generally, the interface between the vehicle subsystems 114 and the telematics unit 110 includes a physical connection as well as an electrical interface such that the data signals communicated from/to the vehicle subsystems 114 may be further communicated to/from the telematics unit 110. Standardizing the telematics unit 110 across vehicle manufacturers allows reduced cost and increased compatibility for evolving technology, allowing more desirable product and service offerings and revenue opportunities as technology progresses.

In various alternative embodiments, the vehicle 112 subsystem connection and vehicle interface 116 between the telematics unit 110 and the vehicle subsystems 114 can be implemented in a variety of alternative ways. For example, one embodiment can use a USB interface and associated connector. USB is an industry standard developed in the mid-1990's that defines the cables, connectors, and communications protocols typically used for connection, communication and power supply between electronic devices. In any of these various embodiments, the vehicle interface 116 enables the telematics unit 110 to access the vehicle subsystems 114 in the vehicle 112. As a result, the telematics unit 110 can communicate with vehicle subsystems or ECUs (e.g., vehicle subsystems 114) in the vehicle 112.

As shown in FIG. 2, the telematics unit 110 can also couple with one or more mobile devices 130 as part of a mobile device interface supporting a user interface on the mobile device 130. In various embodiments, the mobile device interface and user interface between the telematics unit 110 and the mobile devices 130 can be implemented in a variety of ways. For example, in one embodiment, the mobile device interface and user interface between the telematics unit 110 and the mobile devices 130 can be implemented using a networked connection 111 and the network 100. In other embodiments, a direct mobile device interface 131 and user interface between the telematics unit 110 and the mobile devices 130 can be implemented using a direct data connection, such as a USB interface and associated connector. In a particular configuration, a USB On-The-Go, (USB OTG) interface can be used to enable the mobile devices 130 to act as a host device. USB OTG is a standard specification that allows USB devices such as mobile computing devices or mobile phones to act as a host, allowing other USB devices, like the telematics unit 110, to be attached to and communicate with them.

In another embodiment, the direct mobile device interface 131 and user interface between the telematics unit 110 and the mobile devices 130 can be implemented using a wireless protocol, such as WiFi or Bluetooth™ (BT). WiFi is a popular wireless technology allowing an electronic device to exchange data wirelessly over a computer network. Bluetooth™ is a wireless technology standard for exchanging data over short distances. A wireless data interface module 216 is provided in the telematics unit 110 to support the WiFi, Bluetooth™, or other wireless interface.

Referring still to FIG. 2, the telematics unit 110 can communicate with the central server 120, mobile devices 130, networked users/clients 140, and network resources 150 via the network 100. The network 100 represents a conventional wide area data or communication network, such as the Internet, cellular telephone network, satellite or GPS network, UHF network, broadcast network, WiFi network, peer-to-peer network, Voice Over IP (VoIP) network, or the like, that can be received in vehicle 112 or directly by the telematics unit 110 via the wireless data interface 216. Such cellular data networks are currently available (e.g., Verizon™, AT&T™, T-Mobile™, etc.). Such satellite-based data networks are also currently available (e.g., HughesNet™, Iridium™, etc.). Satellite-based GPS networks are also widely available. The other conventional networks, such as UHF networks, WiFi networks, peer-to-peer networks, Voice Over IP (VoIP) networks, and the like are also well-known.

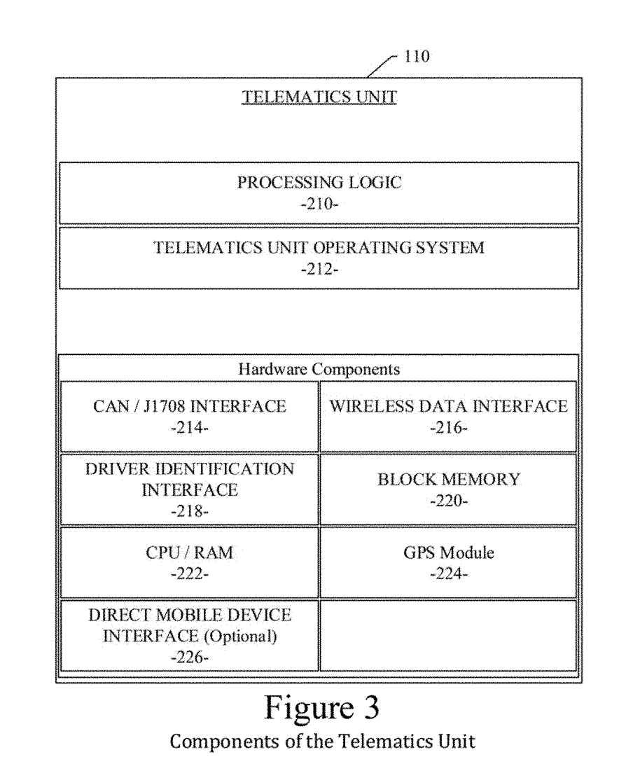

Referring now to FIG. 3, the components of the telematics unit 110 of an example embodiment are illustrated. The telematics unit 110 can include a central processing unit (CPU) 222 with a conventional random access memory (RAM). The CPU 222 can be implemented with any available microprocessor, microcontroller, application specific integrated circuit (ASIC), or the like. The telematics unit 110 can also include a block memory 220, which can be implemented as any of a variety of data storage technologies, including standard dynamic random access memory (DRAM), Static RAM (SRAM), non-volatile memory, flash memory, solid-state drives (SSDs), mechanical hard disk drives, or any other conventional data storage technology. Block memory 220 can be used in an example embodiment for the storage of raw vehicle data, processed vehicle data, and/or aggregated vehicle data as described in more detail below. The telematics unit 110 can also include a GPS receiver module 224 to support the receipt and processing of GPS data from the GPS satellite network. The GPS receiver module 224 can be implemented with any conventional GPS data receiving and processing unit. The telematics unit 110 can also include a telematics unit operating system 212, which can be layered upon and executed by the CPU 222 processing platform. In one example embodiment, the telematics unit operating system 212 can be implemented using a Linux™ based operating system. It will be apparent to those of ordinary skill in the art that alternative operating systems and processing platforms can be used to implement the telematics unit 110. The telematics unit 110 can also include processing logic 210, which can be implemented in software, firmware, or hardware. The processing logic 210 implements the various methods for driver evaluation, rating, and skills improvement of the example embodiments described in detail below.

As described above, the telematics unit 110 can include several interfaces to enable data communications with a variety of connected devices. In an example embodiment, these interfaces can include a CAN/J1708 interface 214, a wireless data transceiver interface 216, a driver identification interface 218, the GPS module 224, and optionally a direct mobile device interface 226. The wireless data transceiver interface 216 can include a BT/WiFi/WAN module to support a WAN, WiFi, or Bluetooth™ interface between the network 100, the mobile devices 130, and the telematics unit 110. The driver identification interface 218 is provided to enable a vehicle driver to present an electronically readable identification card, identification device, or credentials to a driver identification device, with which the driver can be uniquely identified to the telematics unit 110. The driver identification device can be a standard card reader, scanner, barcode or QR code scanner, magnetic strip reader, wireless key fob reader, smartcard reader, digital tachograph, or the like. Alternatively, the driver can provide identification credentials via an app on the mobile device 130. In any case, the driver identification interface 218 is configured to receive a driver-unique identification code or dataset used by the telematics unit 110 to associate vehicle data captured from the vehicle 112 with the particular driver identified by the driver-unique identification dataset.

In the example embodiment, the software or firmware components of the telematics unit 110 (e.g., the processing logic 210 and the telematics unit operating system 212) can be dynamically upgraded, modified, and/or augmented by use of a data connection with a networked node (e.g., the central server 120) via network 100 or the mobile device 130. The telematics unit 110 can periodically query the networked node for updates or updates can be pushed to the telematics unit 110. Additionally, the telematics unit 110 can be remotely updated and/or remotely configured to add or modify the list of extensible characteristics, the set of preprocessing events, the degree of trip difficulty factors, and the factors used in generating the driver rating. The telematics unit 110 can also be remotely updated and/or remotely configured to add or modify a specific vehicle 112 identification, description, or specification, such as engine type, available vehicle subsystems, and other vehicle-specific characteristics.

As used herein, the term CAN bus or J1708 interface refers to any bus or data communications system used in a vehicle 112 for communicating signals between a vehicle subsystem, ECUs, or other vehicle 112 components and the telematics unit 110. The CAN/J1708 bus may be a bus or interface that operates according to versions of the CAN or J1708 specifications, but is not limited thereto. The term CAN bus or J1708 interface can therefore refer to buses, interfaces, or data communications systems that operate according to other specifications, including those that might be developed in the future.

As used herein and unless specified otherwise, the term mobile device includes any computing or communications device that can communicate with the telematics unit 110 described herein to obtain read or write access to data signals, messages, or content communicated on a network, CAN bus or J1708 interface, or via any other mode of inter-process data communications. In many cases, the mobile device 130 is a handheld, portable device, such as a smart phone, mobile phone, cellular telephone, tablet computer, laptop computer, display pager, radio frequency (RF) device, infrared (IR) device, global positioning device (GPS), Personal Digital Assistant (PDA), handheld computers, wearable computer, portable game console, other mobile communication and/or computing device, or an integrated device combining one or more of the preceding devices, and the like. Additionally, the mobile device 130 can be a computing device, personal computer (PC), multiprocessor system, microprocessor-based or programmable consumer electronic device, network PC, diagnostics equipment, a system operated by a vehicle 112 manufacturer or service technician, and the like, and is not limited to portable devices. The mobile device 130 can receive and process data in any of a variety of data formats. The data format may include or be configured to operate with any programming format, protocol, or language including, but not limited to, JavaScript™, C++, iOS™, Android™, etc.

As used herein and unless specified otherwise, the term central server, network client, client, or network resource includes any device, system, or service that can communicate with the telematics unit 110 described herein to obtain read or write access to data signals, messages, or content communicated on a network, CAN bus or J1708 interface, or via any other mode of inter-process data communications. In many cases, the central server, network client, client, or network resource is a data network accessible computing platform, including client or server computers, websites, mobile devices, peer-to-peer (P2P) network nodes, and the like. Additionally, the central server, network client, client, or network resource can be a web appliance, a network router, switch, bridge, gateway, diagnostics equipment, a system operated by a vehicle 112 manufacturer or service technician, or any machine capable of executing a set of instructions (sequential or otherwise) that specify actions to be taken by that machine. Further, while only a single machine is illustrated, the term “machine” can also be taken to include any collection of machines that individually or jointly execute a set (or multiple sets) of instructions to perform any one or more of the methodologies discussed herein. The central server, network client, client, or network resource may include any of a variety of providers or processors of network transportable digital content. Typically, the data format that is employed is Extensible Markup Language (XML), however, the various embodiments are not so limited, and other data formats may be used. For example, data formats other than Hypertext Markup Language (HTML)/XML or formats other than open/standard data formats can be supported by various embodiments. Any electronic file format, such as Portable Document Format (PDF), audio (e.g., Motion Picture Experts Group Audio Layer 3-MP3, and the like), video (e.g., MP4, and the like), and any proprietary interchange format defined by specific content sites can be supported by the various embodiments described herein.

The wide area data network 100 (also denoted the network cloud) used with the central server 120, network client 140, mobile devices 130, or network resource 150 can be configured to couple one computing or communication device with another computing or communication device. The network may be enabled to employ any form of computer readable data or media for communicating information from one electronic device to another. The network 100 can include the Internet in addition to other wide area networks (WANs), cellular telephone networks, metro-area networks, local area networks (LANs), other packet-switched networks, circuit-switched networks, direct data connections, such as through a universal serial bus (USB) or Ethernet port, other forms of computer-readable media, or any combination thereof. On an interconnected set of networks, including those based on differing architectures and protocols, a router or gateway can act as a link between networks, enabling messages to be sent between computing devices on different networks. Also, communication links within networks can typically include twisted wire pair cabling, USB, Firewire, Ethernet, or coaxial cable, while communication links between networks may utilize analog or digital telephone lines, full or fractional dedicated digital lines including T1, T2, T3, and T4, Integrated Services Digital Networks (ISDNs), Digital User Lines (DSLs), wireless links including satellite links, cellular telephone links, or other communication links known to those of ordinary skill in the art. Furthermore, remote computers and other related electronic devices can be remotely connected to the network via a modem and temporary telephone link.

The network 100 may further include any of a variety of wireless sub-networks that may further overlay stand-alone ad-hoc networks, and the like, to provide an infrastructure-oriented connection. Such sub-networks may include mesh networks, Wireless LAN (WLAN) networks, cellular networks, and the like. The network may also include an autonomous system of terminals, gateways, routers, and the like connected by wireless radio links or wireless transceivers. These connectors may be configured to move freely and randomly and organize themselves arbitrarily, such that the topology of the network may change rapidly.

The network 100 may further employ a plurality of access technologies including 2nd (2G), 2.5, 3rd (3G), 4th (4G) generation radio access for cellular systems, WLAN, Wireless Router (WR) mesh, and the like. Access technologies such as 2G, 3G, 4G, and future access networks may enable wide area coverage for mobile devices, such as one or more of client devices, with various degrees of mobility. For example, the network may enable a radio connection through a radio network access, such as Global System for Mobile communication (GSM), General Packet Radio Services (GPRS), Enhanced Data GSM Environment (EDGE), Wideband Code Division Multiple Access (WCDMA), CDMA2000, and the like. The network may also be constructed for use with various other wired and wireless communication protocols, including TCP/IP, UDP, SIP, SMS, RTP, WAP, CDMA, TDMA, EDGE, UMTS, GPRS, GSM, UWB, WiMax, IEEE 802.11x, and the like. In essence, the network 100 may include virtually any wired and/or wireless communication mechanisms by which information may travel between one computing device and another computing device, network, and the like.

In a particular embodiment, a mobile device 130, a network client 140, and/or a network resource 150 may act as a client device enabling a user to access and use the telematics unit 110 to interact with one or more vehicle subsystems 114. These client devices may include virtually any computing device that is configured to send and receive information over a network, such as network 100 as described herein. Such client devices may include mobile devices, such as cellular telephones, smart phones, tablet computers, display pagers, radio frequency (RF) devices, infrared (IR) devices, global positioning devices (GPS), Personal Digital Assistants (PDAs), handheld computers, wearable computers, game consoles, integrated devices combining one or more of the preceding devices, and the like. The client devices may also include other computing devices, such as personal computers (PCs), multiprocessor systems, microprocessor-based or programmable consumer electronics, network PC's, and the like. As such, client devices may range widely in terms of capabilities and features. For example, a client device configured as a cell phone may have a numeric keypad and a few lines of monochrome LCD display on which only text may be displayed. In another example, a web-enabled client device may have a touch sensitive screen, a stylus, and a color LCD display screen in which both text and graphics may be displayed. Moreover, the web-enabled client device may include a browser application enabled to receive and to send wireless application protocol messages (WAP), and/or wired application messages, and the like. In one embodiment, the browser application is enabled to employ HyperText Markup Language (HTML), Dynamic HTML, Handheld Device Markup Language (HDML), Wireless Markup Language (WML), WMLScript, JavaScript, EXtensible HTML (xHTML), Compact HTML (CHTML), and the like, to display and send a message with relevant information.

The client devices may also include at least one client application that is configured to receive content or messages from another computing device via a network transmission. The client application may include a capability to provide and receive textual content, graphical content, video content, audio content, alerts, messages, notifications, and the like. Moreover, the client devices may be further configured to communicate and/or receive a message, such as through a Short Message Service (SMS), direct messaging (e.g., Twitter™), email, Multimedia Message Service (MMS), instant messaging (IM), internet relay chat (IRC), mIRC, Jabber, Enhanced Messaging Service (EMS), text messaging, Smart Messaging, Over the Air (OTA) messaging, or the like, between another computing device, and the like. The client devices may also include a wireless application device on which a client application is configured to enable a user of the device to send and receive information to/from network resources wirelessly via the network.

Telematics unit 110 can be implemented using systems that enhance the security of the execution environment, thereby improving security and reducing the possibility that the telematics unit 110 and the related services could be compromised by viruses or malware. For example, telematics unit 110 can be implemented using a Trusted Execution Environment, which can ensure that sensitive data is stored, processed, and communicated in a secure way.

As described above, the telematics unit 110 may receive vehicle data signals from the vehicle subsystems 114 that can be converted, filtered, processed, aggregated, stored, and forwarded to the central server 120, a network client 140, a mobile device 130 app/user, or a network resource 150. As such, the telematics unit 110 may communicate the processed vehicle data to any of a variety of client and/or server systems. More specifically, in one example embodiment, the telematics unit 110 may be configured to wirelessly communicate the processed vehicle data to the mobile device 130 via a networked or direct data interface. The telematics unit 110 may support several configurations. In some embodiments, the telematics unit 110 may establish a secure data channel between the telematics unit 110 and the central server 120, a network client 140, a mobile device 130 user, or a network resource 150. In addition to or as an alternative to the secure channel, the telematics unit 110 may encrypt the processed vehicle data for transfer to the client or server devices. The receiving device may decrypt the data signals using standard techniques. The inclusion of the secure channel and/or encryption may enhance security of the processed vehicle data communicated to the client or server devices. Additionally, because each telematics unit 110 is in data communication with network 100, each telematics unit 110 may communicate via network 100 with other telematics units 110 located in other vehicles or locations. As a result, the telematics units 110 in a plurality of vehicles can form a data sharing network to share a variety of information including, current traffic or weather conditions in each vehicle location and along each route, current vehicle or driver status, current driver or vehicle feedback, evaluation or rating information, corporate messages, advisories, alerts, or warnings, and the like. Because the current traffic and weather information can be shared among the network of telematics units 110, the degree of trip difficulty (DTD) generated by an example embodiment, as described below, can be adjusted to correlate with dynamically changing conditions on routes travelled by the vehicles in which the telematics units 110 are located. As such, driver ratings can be adjusted and normalized based on actual real-time conditions on the routes being travelled.

In embodiments in which the telematics unit 110 wirelessly communicates the processed vehicle data to the client or server devices, the telematics unit 110 can include wireless capabilities such as Bluetooth™, Wi-Fi, 3G, 4G, LTE, etc. For example, if the telematics unit 110 includes a Bluetooth™ transceiver as part of the wireless data interface module 216, the telematics unit 110 can communicate wirelessly with the mobile device 130 using Bluetooth™ capabilities. Generally, the mobile device 130 includes one or more mobile device applications (apps) that process the data signals from/for the telematics unit 110. The mobile device applications can produce a user interface with which a user may monitor and control the operation of vehicle subsystems 114 via the telematics unit 110 and the mobile device 130. The mobile device application (app) may be loaded, downloaded, or installed on the mobile device 130 using conventional processes. Alternatively, the mobile device 130 may access a mobile device application via the network cloud 100, for example. The mobile device application may also be accessed and used as a Software as a Service (SaaS) application. The mobile device application may be written or created to process vehicle data, in whole or in part, in the mobile device 130 format rather than (or in addition to) transferring the data to the central server 120.

By processing the vehicle data signals from the vehicle subsystems 114 at the telematics unit 110 and/or at a central server 120 application or a mobile device 130 app, the network nodes, including the central server 120 and the mobile device 130 may function better than a central server 120 application and the mobile device 130 app without the vehicle data or the applications may be able to provide functionality not possible without the vehicle data signals. Examples of the central server or mobile device applications are not limited to the above examples. The central server application or mobile device application may include any application that processes, abstracts, or evaluates data signals from the vehicle subsystems 114 or transmits write/control signals to the vehicle subsystems 114.

### Systems and Methods for Driver Evaluation, Rating, and Skills Improvement

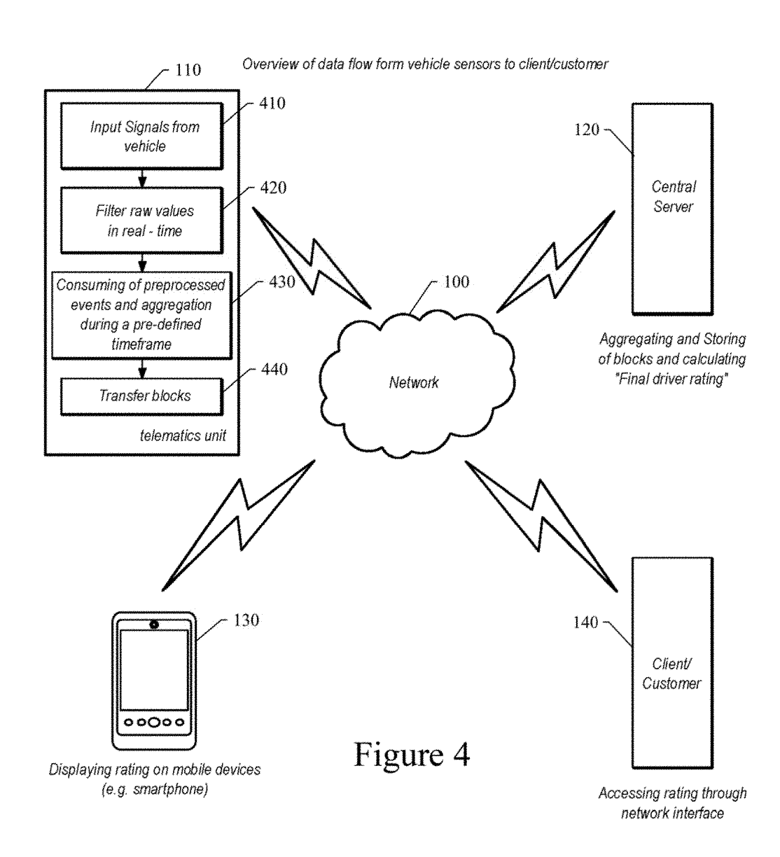

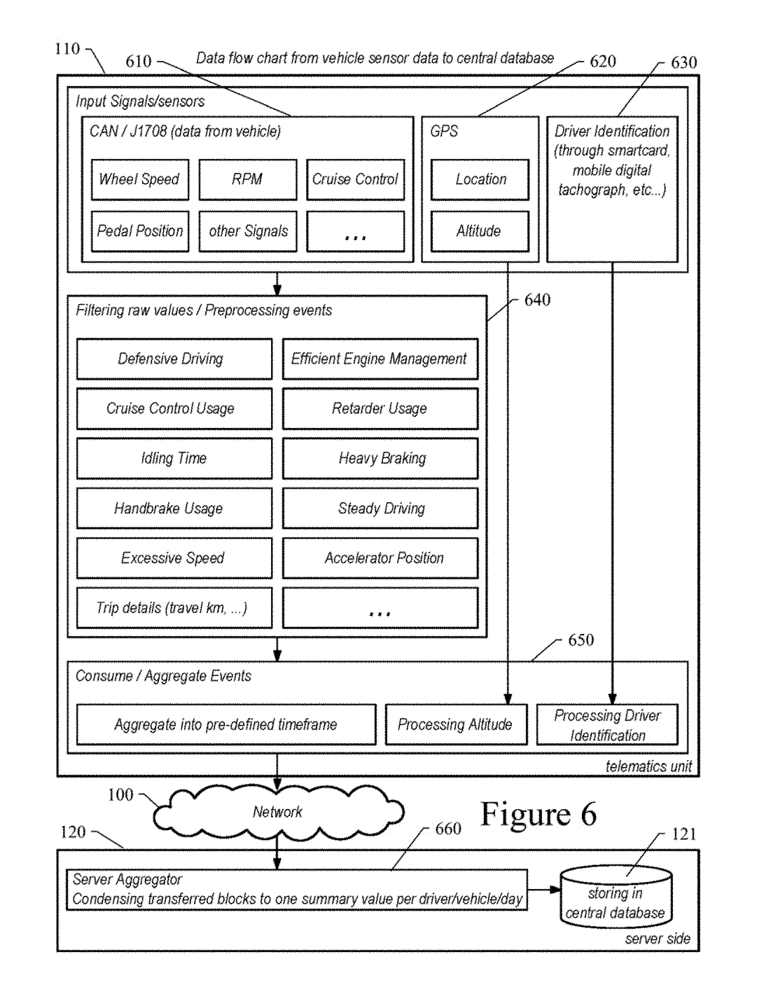

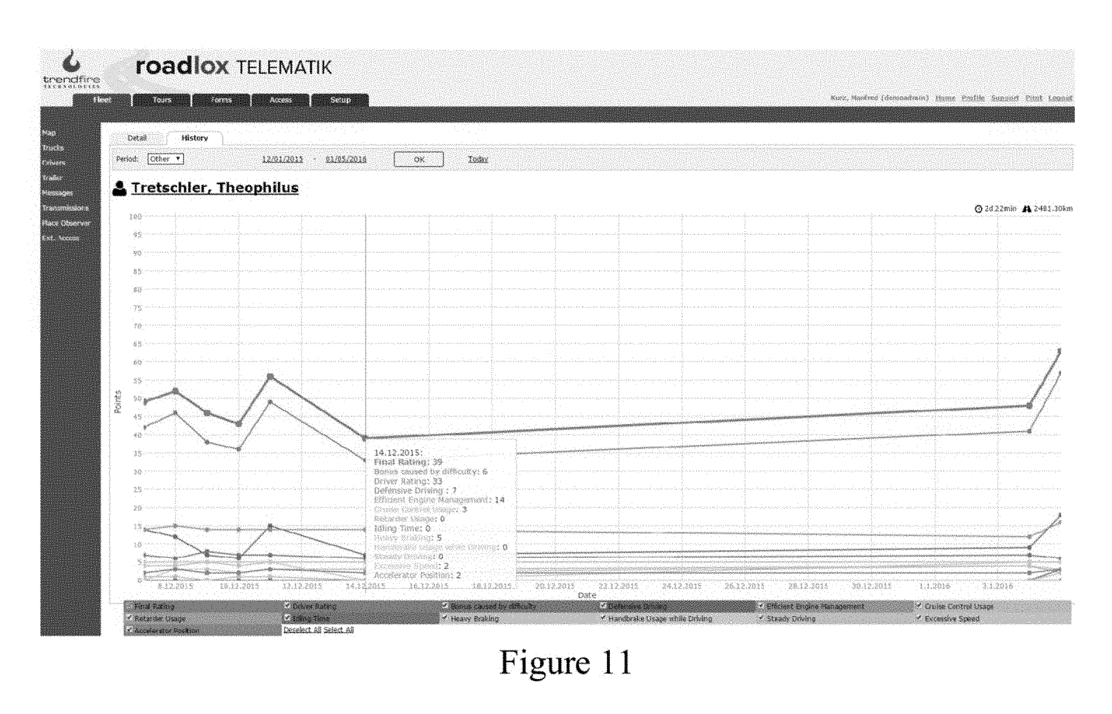

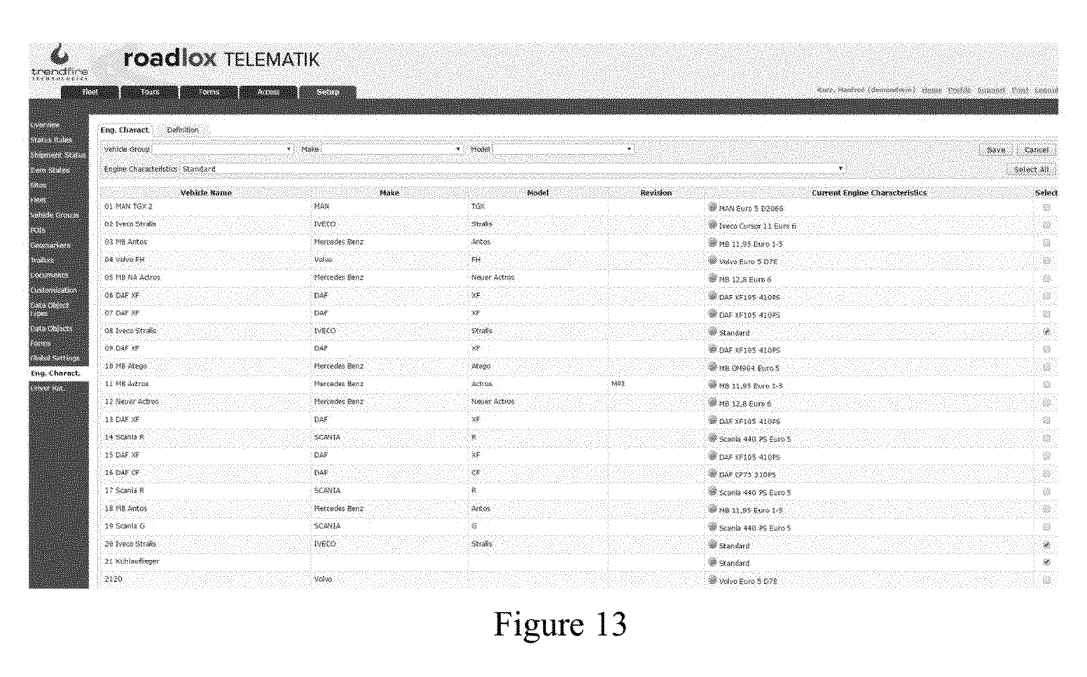

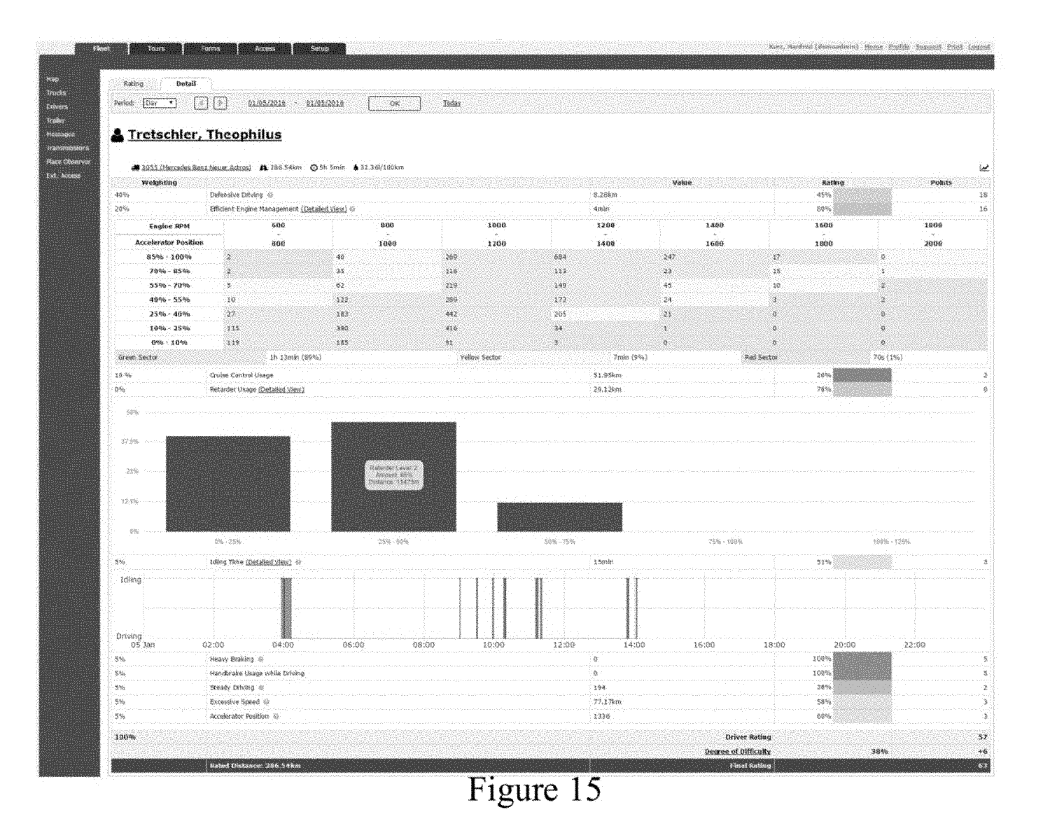

FIG. 4 illustrates an example embodiment of a processing flow showing an overview of the vehicle data flow from the vehicle subsystems 114 to one or more of the data consumers (e.g., the central server 120, a network client 140, a mobile device 130 app, and/or a network resource 150). The data processing performed by the example embodiments as described herein in connection with the example embodiments shown in FIGS. 4 through 19 can be implemented as processing logic coded into the processing logic 210 of telematics unit 110, an application executing at central server 120, and/or an app executing within a mobile device 130. As described above for a variety of example embodiments, the telematics unit 110 can obtain a set of vehicle data from vehicle 112 via vehicle interface 116 and the CAN/J1708 interface 214. The vehicle data can correspond to a variety of parameters, signals, data, and the like that represent or are indicative of a current, real-time status of various vehicle subsystems 114. The vehicle data can also represent data obtained, generated, or used by one or more vehicle subsystems 114. For example, the vehicle data can include information indicative of the current wheel speed of vehicle 112, engine RPM, engine status, cruise control status, accelerator or foot brake pedal position, hand brake position, retarder status, vehicle acceleration, current vehicle geographical location and altitude/elevation, odometer value, fuel level, fuel burn rate, and the like (e.g., see block 610 shown in FIG. 6). In a particular embodiment, the telematics unit 110 can also obtain current vehicle geographical location and elevation/altitude, vehicle speed, and acceleration via the GPS module 224 (e.g., see block 620 shown in FIG. 6). As also described above for a variety of example embodiments, the telematics unit 110 can also obtain driver credentials from the vehicle 112 via vehicle interface 116 and the driver identification interface 218 (e.g., see block 630 shown in FIG. 6). The driver credentials can uniquely identify the particular current driver of the vehicle 112. In other embodiments, the driver credentials can be obtained from a mobile device 130 via network interface 111 or direct mobile device interface 131. Additionally, the telematics unit 110 can also obtain vehicle identification information that uniquely identifies the particular vehicle 112. The vehicle identification information can be obtained via the vehicle interface 116 or from a mobile device 130 via network interface 111 or direct mobile device interface 131. It will be apparent to those of ordinary skill in the art in view of the disclosure herein that other vehicle parameters can be included in the vehicle data as well. This raw vehicle data can be retrieved by the telematics unit 110 in real time and at configurable time intervals in a data pull or polling model. In other embodiments, the vehicle subsystems 114 can signal a change in vehicle data status in a data push model.

Referring again to FIG. 4, the raw vehicle data retrieved by the telematics unit 110, as described above, can be fetched in real-time from the vehicle 112 and the other described data sources in processing block 410. In an example embodiment, this raw vehicle data can be stored in a memory device of the telematics 110 or in the network cloud 100. In processing block 420, the raw vehicle data can be pre-filtered in real time to remove duplicative or unnecessary data. Metadata can also be added to the raw vehicle data to timestamp or appropriately label the individual data items of the raw vehicle data.

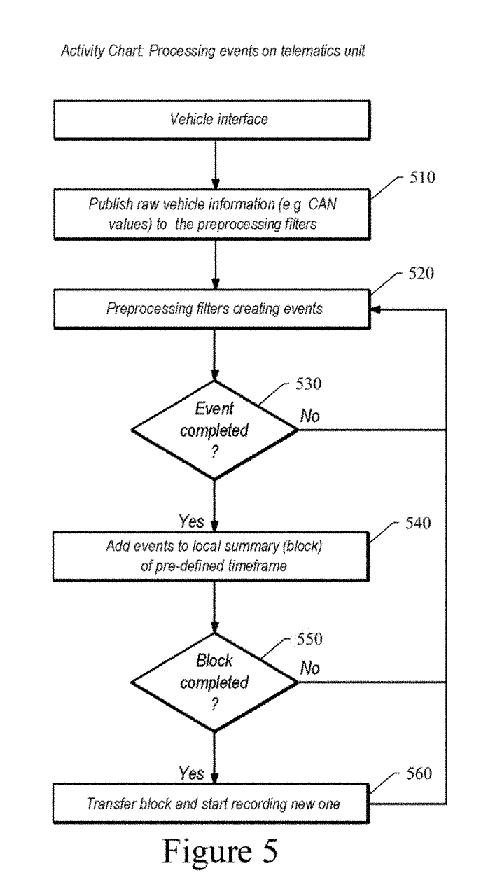

Referring to processing block 430 in FIG. 4, the pre-filtered raw vehicle data can be provided or published to a set of preprocessing filters in the telematics unit 110 to identify, create, and/or trigger one or more events corresponding to the received vehicle data. The filtering and event preprocessing performed in an example embodiment is described in more detail in connection with FIGS. 5 and 6 described below. As a result of the filtering and event preprocessing, a set of data blocks can be created to define a current state of the vehicle 112 and the set of corresponding events occurring in the vehicle 112 over a configurable time period. These data blocks can be transferred to the central server 120 for further processing via network 100 in processing block 440 shown in FIG. 4. In the absence of a reliable network connection, the set of data blocks can be stored or cached in the block memory 220 of the telematics unit 110 until a reliable network connection is restored. Because the time period associated with each data block is fully configurable, the size of each data block and the rate at which the data blocks are transferred to the central server 120 are also configurable.

Referring now to FIG. 5, an example embodiment illustrates a processing flow showing data processing performed by the telematics unit 110 for receiving, converting, filtering, processing, and aggregating the raw vehicle data into configurable data blocks. FIG. 6 illustrates an example embodiment of a system architecture showing data processing performed by the telematics unit 110 for receiving, converting, filtering, processing, and aggregating the raw vehicle data into configurable data blocks. In FIG. 5 at processing block 510, the pre-filtered raw vehicle data can be provided or published to a set of preprocessing filters to identify, create, and/or trigger one or more events corresponding to the received vehicle data. As such, the pre-filtered raw vehicle data can be correlated to a corresponding set of preprocessing events representing activity or state transitions occurring in the vehicle 112. A detail of examples of the preprocessing events in an example embodiment are shown in FIG. 6 at block 640. In general, each preprocessing event of an example embodiment represents some change in status of one or more vehicle systems that may occur over a configurable time, rate, or distance. For example, as shown in FIG. 6 at block 640, the preprocessing events in an example embodiment can include: a defensive driving event, efficient engine management event, cruise control usage event, retarder usage event, idling time event, heavy braking event, handbrake usage event, steady driving event, excessive speed event, accelerator position event, trip details, and the like. In a particular example of a handbrake usage event, the received raw vehicle data may include an indication that the handbrake of vehicle 112 has transitioned from an inactive state to an active state. This may occur when the driver pulls the handbrake in the vehicle 112. When the processing logic 210 of telematics unit 110 detects such a state transition, a handbrake usage event can be generated in processing block 520 shown in FIG. 5. The processing logic 210 can retain information indicative of the current state of the handbrake; and thus, logic 210 can determine when the state of the handbrake has changed. In this relatively simple example of a preprocessing event, the handbrake usage event can be deemed completed when the handbrake state transition occurs. In this case, processing continues through the “Yes” branch of decision block 530 to processing block 540 shown in FIG. 5. At processing block 540, the handbrake usage event can be added to a summary of events being collected during a current timeframe. An example embodiment enables an authorized client/user or a system administrator to configure a timeframe that defines a length of time over which the processing logic 210 collects new preprocessing events in a summary before the summary is loaded into a data block and sent to the central server 120. In an alternative embodiment, the authorized client/user or system administrator can configure a data block length, a quantity of new preprocessing events, or other criteria to define the completion of a current collection of preprocessing events in the summary. Once the current collection of preprocessing events in the summary is completed based on the configurable criteria, processing continues through the “Yes” branch of decision block 550 to processing block 560 shown in FIG. 5. At processing block 560, the completed collection of preprocessing events in the summary is loaded into a data block and sent to the central server 120. A new summary and a corresponding new data block can be generated and subsequent new preprocessing events can be added to the new summary and the corresponding new data block.

In another particular example of preprocessing event processing in an example embodiment (e.g., a cruise control system usage event), the received raw vehicle data may include an indication that the cruise control of vehicle 112 has transitioned from an inactive state to an active state. This may occur when the driver activates the cruise control system in the vehicle 112. When the processing logic 210 of telematics unit 110 detects such a state transition, a cruise control usage event can be generated in processing block 520 shown in FIG. 5. The processing logic 210 can retain information indicative of the current state of the cruise control system; and thus, logic 210 can determine when the state of the cruise control system has changed. In addition, the logic 210 can obtain a current odometer reading value at the time of the cruise control activation event. The current odometer reading can be obtained from the raw vehicle data. In this manner, the logic 210 can determine the distance traveled while the cruise control system is active. The odometer reading value or a distance travelled value can be added to the data associated with the cruise control usage event. As such, certain of the preprocessing events can be configured to cause the fetching of other related data or the activation of related ancillary events. In this example of a preprocessing event, the cruise control usage event can be deemed completed when the cruise control system activation state transition occurs and the odometer data has been fetched. In this case, processing continues through the “Yes” branch of decision block 530 to processing block 540 shown in FIG. 5. At processing block 540, the cruise control usage event can be added to the summary of events being collected during the current timeframe. Once the current collection of preprocessing events in the current summary is completed based on the configurable criteria, processing continues through the “Yes” branch of decision block 550 to processing block 560 shown in FIG. 5. At processing block 560, the completed collection of preprocessing events in the summary is loaded into a data block and sent to the central server 120. A new summary and a corresponding new data block can be generated and subsequent new preprocessing events can be added to the new summary and the corresponding new data block.

In yet another particular example of preprocessing event processing in an example embodiment (e.g., an idling time event), the received raw vehicle data may include both an indication that the wheel speed of vehicle 112 has decreased to zero speed and an indication that the engine in vehicle 112 is still running. This may occur when the driver steps on the brake or disengages the transmission while the engine is still running. When the processing logic 210 of telematics unit 110 detects such a state transition, an idling time event can be generated in processing block 520 shown in FIG. 5. The processing logic 210 can retain information indicative of the current wheel speed and engine status; and thus, logic 210 can determine when the idling time event has occurred. In addition, the logic 210 can obtain a current time value at the time of the idling time event activation. In this manner, the logic 210 can determine the length of time while the vehicle 112 is idle. The current time value or an idle time value can be added to the data associated with the idling time event. As such, certain of the preprocessing events can be configured to cause the fetching of other related data or the activation of related ancillary events. In this example of a preprocessing event, the idling time event can be deemed completed when the idling time event state transition occurs and the current time value has been fetched. In this case, processing continues through the “Yes” branch of decision block 530 to processing block 540 shown in FIG. 5. At processing block 540, the idling time event can be added to the summary of events being collected during the current timeframe. Once the current collection of preprocessing events in the summary is completed based on the configurable criteria, processing continues through the “Yes” branch of decision block 550 to processing block 560 shown in FIG. 5. At processing block 560, the completed collection of preprocessing events in the summary is loaded into a data block and sent to the central server 120. A new summary and a corresponding new data block can be generated and subsequent new preprocessing events can be added to the new summary and the corresponding new data block.

Referring to FIG. 6, this collection and aggregation of preprocessing events into the current summary as described above is shown in block 650. In the example embodiment shown in FIG. 6, when the processing logic 210 loads the completed collection of preprocessing events into a data block, the processing logic 210 can also attach a dataset identifying a current geographical position and elevation/altitude of the vehicle 112. Additionally, the processing logic 210 can also attach a dataset with the driver credentials or other information identifying the driver of the vehicle 112. An identification of the vehicle 112 itself can also be included in the data block sent to the central server 120. In this manner, a plurality of current, real-time data blocks with information representing real-time events occurring in vehicle 112 can be associated with a particular configurable timeframe, a particular vehicle location, a particular driver, and a particular vehicle. As described in more detail below, this information is used to rate, score, evaluate, and educate drivers, fleets, and organizations about the behaviors and performance of a fleet of vehicles.

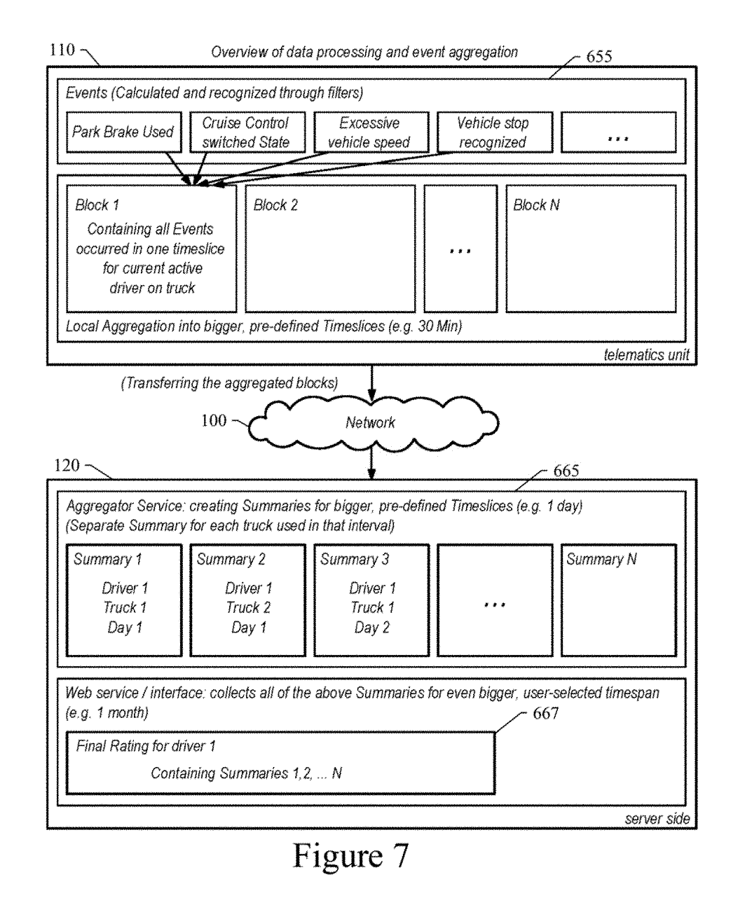

FIG. 7 illustrates an example embodiment of a system architecture showing data processing performed by the telematics unit 110 and the central server 120 for aggregating the processed vehicle data into configurable data blocks and summaries. Block 655 in FIG. 7 illustrates the aggregation of a plurality of preprocessing events (e.g., “Park Brake Used”, Cruise Control Transition“, Excessive Vehicle Speed”, Vehicle Stop” etc.) generated during a current timeframe and added to a summary of events stored in a data block (e.g., Block 1). As described above, an example embodiment enables an authorized client/user or system administrator to configure a timeframe that defines a length of time over which the processing logic 210 collects new preprocessing events in a summary before the summary is loaded into a data block and sent to the central server 120. In an alternative embodiment, the authorized client/user or system administrator can configure a data block length, a quantity of new preprocessing events, or other criteria to define the completion of a current collection of preprocessing events in the summary. As shown in block 655 in FIG. 7, once the current collection of preprocessing events for the current timeframe is completed based on the configurable criteria, the completed collection of preprocessing events in the summary is loaded into a data block (e.g., Block 1) and the data block is staged for transmission to the central server 120 via network 100. As such, the processing logic 210 in telematics unit 110 serves to perform a local aggregation of the vehicle events occurring during a particular configurable timeframe into discrete data blocks representing a timeslice of a configurable size (e.g., 5 minutes, 10 minutes, . . . , 30 minutes, . . . 60 minutes, or any appropriate time period). Once the time period corresponding to the configurable timeslice elapses, the current summary of events is loaded in the current data block and staged for transmission or transfer to the central server 120. A new summary and a new corresponding data block can then be generated or obtained and subsequent new preprocessing events can be added to the new summary and the new corresponding data block (e.g., Block 2). This process of vehicle data gathering, preprocessing, and event aggregation can continue as state changes continue to occur in the vehicle 112. Because an example embodiment provides a highly configurable event aggregation capability, the data processing capabilities, data storage capacities, and the network throughput requirements can be highly tailored for particular applications.

Referring again to FIG. 6 at block 660 and FIG. 7 at block 665, the processing performed by an example embodiment at the central server 120 is illustrated. As described above, the telematics unit 110 can obtain a set of vehicle data from vehicle 112 and other data sources and preprocess the data into a plurality of preprocessed events, which can be sent to the central server 120 in a plurality of data blocks corresponding to an aggregated set of events in a timeslice of a configurable size. As also described above, each data block can also carry additional information including the current vehicle geographical location and elevation/altitude, vehicle speed and acceleration, the current driver credentials, and vehicle identification information. As a result, the data blocks sent to the central server 120 can each include information describing a set of events and/or state transitions occurring in a particular configurable timeframe, in a particular vehicle, with a particular driver. This information can be used by the central server 120 to perform a further aggregation of the vehicle/driver data and an evaluation and rating of the driver for skills improvement. This processing in an example embodiment performed at the central server 120 is described next.

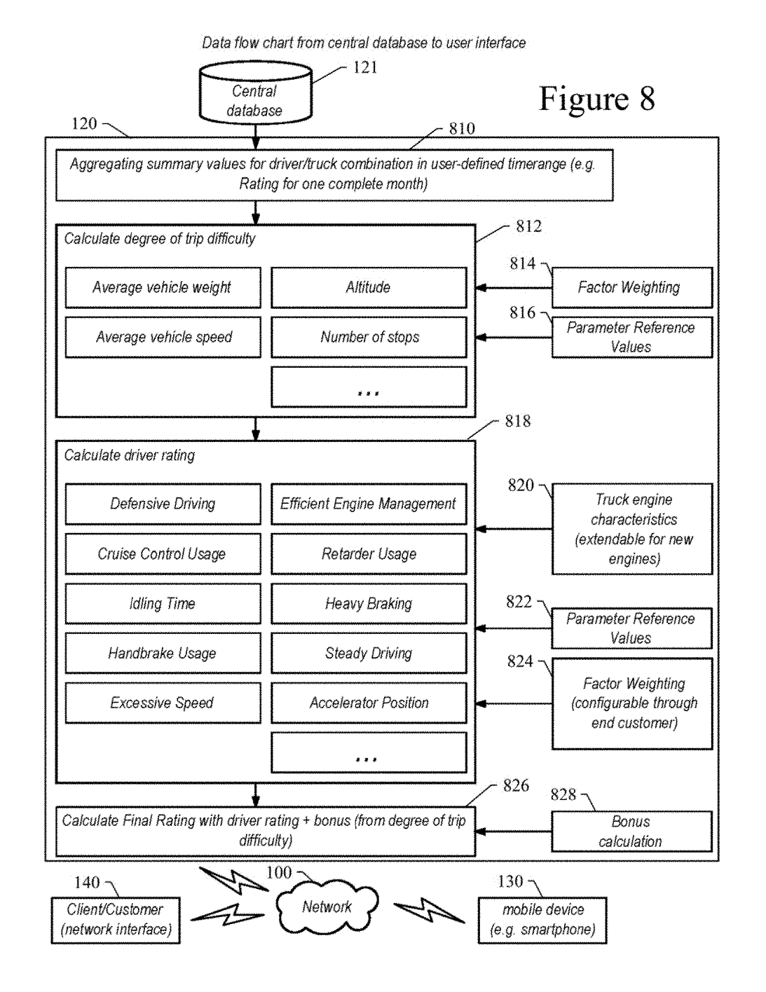

Referring now to FIG. 7 at block 665, the central server 120 can receive a plurality of data blocks that can each include information describing a set of events and/or state transitions occurring in a particular configurable timeframe, in a particular vehicle, with a particular driver. The server 120 can gather the received data blocks in real-time from one or more telematics units 110 in one or more vehicles 112. Given the information included in each of the data blocks as described above, the central server 120 can perform a secondary aggregation of the received data blocks into a plurality of vehicle/driver summaries that cover a configurable time period. For example, as shown in block 665 of FIG. 7, the central server 120 can create a plurality of vehicle/driver summaries (e.g., Summary 1 to Summary N) that include the event and status transition information from all data blocks received from a telematics unit 110 that relate to a particular driver (e.g., Driver 1), a particular vehicle (e.g., Truck 1) and a particular configurable time period (e.g., Day 1). The time period covered by each of the vehicle/driver summaries can be configured by an authorized client/customer or a system administrator. For example, the vehicle/driver summaries can be configured to include the event and status transition information for a particular vehicle/driver combination over any time period, such as the previous hour, an 8-hour period, a 24-hour period, a week, month, year, or any defined time period. As such, the vehicle/driver summaries represent a view of the activity for a vehicle/driver combination in the configured time period. Similarly, the central server 120 can generate a vehicle/driver summaries for different combinations of drivers, vehicles, and time periods. For example, as shown in block 665 of FIG. 7, the central server 120 can create a plurality of vehicle/driver summaries corresponding to particular time periods (e.g., Summary 2: Driver 1/Truck 2/Day 1; Summary 3: Driver 1/Truck 1/Day 2; . . . Summary N: Driver N/Truck N/Day N). In an example embodiment, the vehicle/driver summaries can depend on the drivers and the driven vehicles. As such, when a particular driver drives two different vehicles within the same configured time period (e.g., on the same day), the central server 120 can generate two “one day vehicle/driver summaries” for that time period (e.g., day), one vehicle/driver summary for Vehicle A and one vehicle/driver summary for Vehicle B. This allows the example embodiment to rate driver performance on Vehicle A, Vehicle B or on both vehicles together (A+B). For example, the example embodiment can rate driver performance on multiple vehicles driven in a given time period. Once the central server 120 generates a secondary aggregation of the data blocks into a plurality of vehicle/driver summaries and stores the summaries into a server-accessible database or datastore 121, the central server 120 can initiate a process for scoring and rating each driver based on their corresponding vehicle/driver summaries (block 667 in FIG. 7). This scoring and rating process for an example embodiment is illustrated in more detail in FIG. 8 and described below.

FIG. 8 illustrates an example embodiment of a system architecture showing data processing performed by the central server 120 for calculating degree of trip difficulty values and raw driver score values from the configurable data blocks and vehicle/driver summaries and for delivering the final rating information to one or more of the client devices (e.g., a network client 140, a mobile device 130 app, and/or a network resource 150). In an example embodiment, the vehicle/driver summary information detailing the activity for a vehicle/driver combination over the configured time period as obtained from the telematics units 110 can be used by the central server 120 to aggregate the vehicle/driver summaries into a variety of different datasets (block 810 in FIG. 8). For example, the activity data associated with a particular driver in a particular configured or specified timeframe can be extracted into a dataset. For another example, the activity data associated with a particular vehicle in a particular configured or specified timeframe can be extracted into another dataset. Combinations of these qualifiers can also be extracted. For example, the activity data associated with a particular driver driving a particular vehicle in a particular configured or specified timeframe can be extracted into a dataset. For another example, the activity data associated with a particular driver driving a particular vehicle on a particular route from point A to point B in a particular configured or specified timeframe can also be extracted into a dataset. In fact, a dataset corresponding to most any combination of driver, vehicle, and timeframe can be extracted into a dataset using the information received from the telematics units 110 and processed by the central server 120. As a result, the example embodiments can provide a rich and detailed analysis of the driving and driver activity associated with a fleet of vehicles and drivers. Moreover, the analysis provided by the example embodiments can enable accurate comparisons of datasets representing multiple dimensions of the driving and driver activity. These comparisons, along with a user-configurable set of weighting factors, enable the example embodiments to normalize the driving and driver activity across a variety of dimensions as described in more detail below.

Referring again to FIG. 8, the example embodiment can use the datasets described above to generate for each driver a normalized Driver Evaluation Rating (DER) represented by a value between 0% and 100%, where 0% represents a bad (unacceptable) driving style and 100% represents the best possible driving style. The DER is based upon driving and driver activity datasets, weighted parameters, and the data processing described herein. In the various example embodiments, the DER is normalized and therefore independent of vehicle makes, models, and engine types as used by the vehicle driver over any defined period of time. In an example embodiment, the DER can be based on a combination of a Degree of Trip Difficulty (DTD) and a Raw Driver Score (RDS). The generation of the DTD and the RDS are described in more detail below. In one embodiment, the RDS is generated and then adjusted based on the DTD.

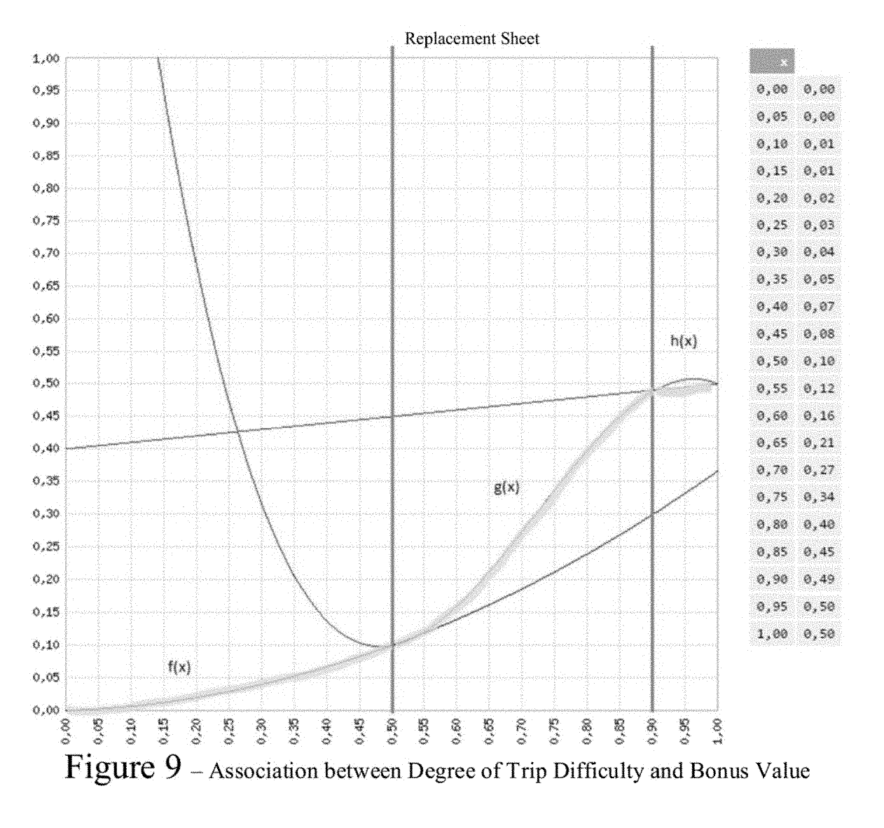

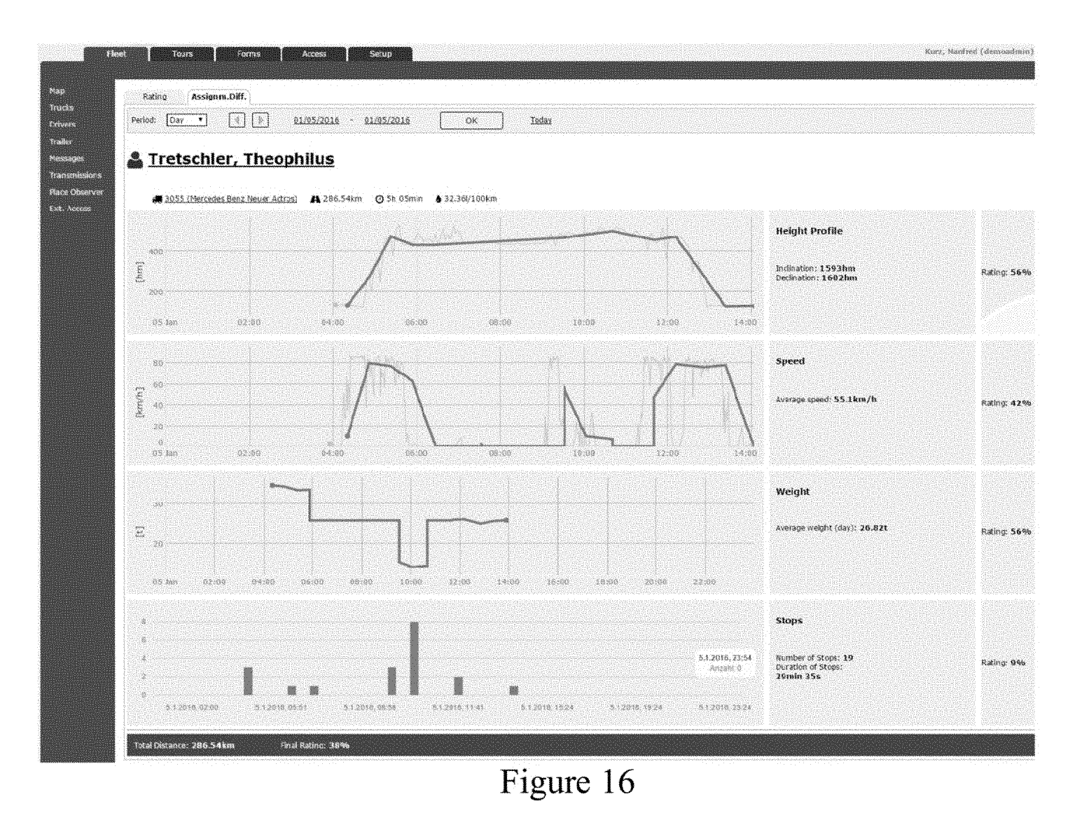

The datasets described above can be used to generate at least two important metrics: 1) a Degree of Trip Difficulty (DTD), and 2) a Raw Driver Score (RDS) that can be used to generate the Driver Evaluation Rating (DER), which represents a final driver rating. The DTD represents a consolidation of a variety of weighted factors associated with a particular route driven in a particular vehicle during the configured timeframe. The DTD is used to quantify the difficulty of travelling the route in the particular vehicle at the particular time. As shown in FIG. 8 at block 812, the associated factors from which the DTD is derived can include, the average weight of the vehicle (Vehicle Weight Profile), the changes in altitude/elevation of the route (Route Height Profile), the average speed of the vehicle over the route (Speed Profile), the number of stops, and a variety of other factors associated with the difficulty of travelling the associated route. The average weight can be collected through the vehicle CAN/J1708 interface 214. The degree of trip difficulty increases with the total vehicle load (e.g., higher total vehicle weight results in higher trip difficulty). When the vehicle does not provide any weight information via the CAN/J1708 interface 214, a total vehicle load of 75% (e.g., 30000 kg, 66138 lbs.) is assumed for further calculations. It will be apparent to those of ordinary skill in the art in view of the disclosure herein that other assumed total vehicle loads can similarly be used. In an example embodiment, the total altitude/elevation difference of the rated trip is calculated via the GPS signal. This value indicates the total altitude/elevation difference and does not differentiate between going upwards or downwards. In an example embodiment, the average vehicle speed values can be collected and calculated through the vehicle CAN/J1708 interface 214. A lower average speed is reflected in an increased trip difficulty and the reverse. The highest possible rating is achieved through an average speed of 20 km/h (12 mph). An average speed greater than 80 km/h (50 mph) will result in the lowest possible score. Every time the received vehicle speed (via the vehicle CAN/J1708 interface 214) reaches 0 km/h, a vehicle stop event is recognized and counted. A minimum vehicle speed of 5 km/h (3 mph) can be required between two consecutive stops. If this requirement is not met, both stops are combined and counted as one vehicle stop event. It will be apparent to those of ordinary skill in the art in view of the disclosure herein that other average, minimum, and maximum speed values can similarly be used. It will also be apparent to those of ordinary skill in the art in view of the disclosure herein that a variety of other factors associated with a particular route driven in a particular vehicle during the configured timeframe can be used in analyzing and rating the driving behavior of vehicle drivers. Additionally, the example embodiment enables each of the factors in the route difficulty quantification to be configurably weighted with a weighting value as shown in block 814. Each configurable weighting value allows the authorized client/user or a system administrator to configurably define a significance or priority of each factor. The configurable weighting factor can be considered a coefficient on the particular factor of the route difficulty quantification. In one embodiment, a higher value weighting factor can correspond to a higher significance of the corresponding factor in the route difficulty quantification. In an example embodiment, a set of parameter reference values can also be provided as shown in block 816. The parameter reference values can be used to establish a set of baseline values from which each of the factors can be based. As such, a set of average, expected, or desired reference parameters can be established for each of the factors in the route difficulty quantification. As a result, the example embodiment can provide a highly configurable quantification of the difficulty of any route travelled by one of more vehicles reporting activity via data blocks sent to the central server 120. Moreover, the configurable weighting factors used in the route difficulty quantification can be viewed and readily configured by a client/user or system administrator using a web-based or mobile device-based user interface. An example embodiment of such a user interface for viewing and configuring the configurable weighting factors used in the route difficulty quantification is shown in FIG. 16. Changes in weighting factors or engine characteristics can be immediately applied to all past and future visualized or calculated driver evaluations. The DTD can result in additional percentage points or a bonus value for the final driver rating. The calculation of these additional percentage points is not a linear function. Three different functions can be used based on the calculated points. These functions and the association between the DTD and the corresponding bonus value are shown in FIG. 9. For example, a DTD of 60% leads to 16 bonus points, which can be added to the raw driver score and results in the final driver rating.

Referring again to FIG. 8, the generation of the Raw Driver Score (RDS) in an example embodiment is shown in block 818 of FIG. 8. In an example embodiment, the RDS can represent a consolidation of a set of weighted values corresponding to the set of events or activity detected in the particular vehicle driven by the particular driver in the timeframe of interest. Alternatively or in addition, the RDS can represent a consolidation of a set of weighted values corresponding to a set of activities or behaviors of interest to a target market of customers or a vehicle fleet. In an example embodiment, a set of factors are defined that are represent a collection of activities, behaviors, or characteristics of interest in analyzing and rating the driving behavior of vehicle drivers. In the example embodiment, these factors are consolidated, as described in more detail below, to generate the Raw Driver Score (RDS), which is used in the calculation of the Final Driver Rating (DER). In the example embodiment, these factors, as shown in block 818 of FIG. 8, can include the following:
Defensive Driving (total distance travelled while applying the foot brake)
Efficient Engine Management
Cruise Control Usage
Retarder Usage
Idling Time
Heavy Braking
Handbrake Usage while Driving
Steady Driving
Excessive Speed
Accelerator Position

In the example embodiment, the Defensive Driving factor represents the relation between the total distance travelled and the total usage of the footbrake measured in meters. This excludes the usage of the retarder or any other regenerative or non-wearing brakes.

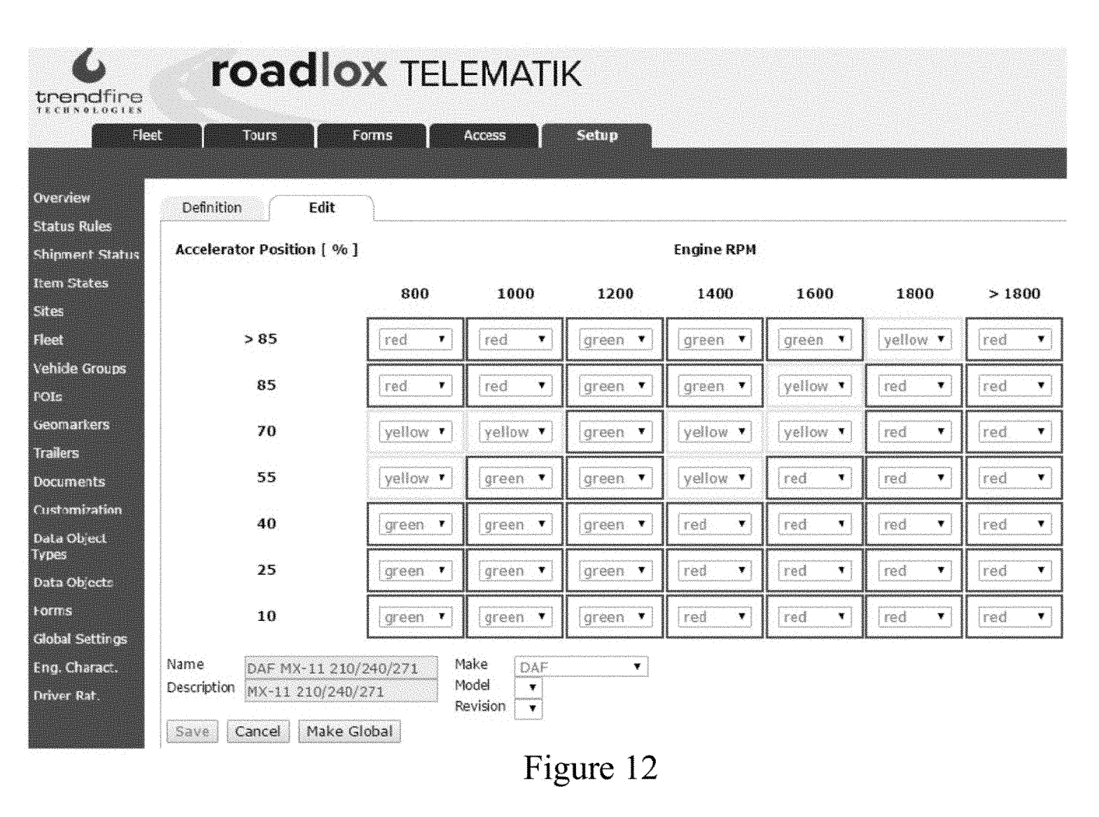

In the example embodiment, the Efficient Engine Management factor represents the efficient usage of the vehicle engine as monitored and rated through accelerator pedal usage and the engine RPM. The total band of possible combinations of pedal usage (0-100%) and engine RPM (600-2000 rpm for European vehicles) is displayed as a matrix graph in the web interface of an example embodiment (e.g., see FIG. 12). It is possible to assign an engine characteristic, which defines the allowed (green), tolerated (yellow) and forbidden (red) engine speed/accelerator pedal combinations. This factor only rates the times in the red and yellow defined sections and only applies for vehicle speeds less than 75 km/h. It will be apparent to those of ordinary skill in the art in view of the disclosure herein that other RPM or speed values can similarly be used. The Efficient Engine Management factor of an example embodiment is based on a vehicle-specific engine characteristics map, which is fully customizable by the client/customer. As shown in block 820 of FIG. 8, vehicle characteristics and vehicle engine characteristics can be pre-configured and provided as an input to the processing logic of the central server 120. Changes in engine characteristics can be immediately applied to all past and future visualized or calculated driver evaluations.

In the example embodiment, the Cruise Control Usage factor represents the relation between total driven kilometers and the distance driven with active cruise control. Higher usage of cruise control results in a higher driver rating.

In the example embodiment, the Retarder Usage factor represents the relation between total braking distance and the distance with an active retarder. Total braking distance is calculated as the distance with the footbrake active plus the distance with the retarder active.

In the example embodiment, the Idling Time factor represents the relation between the total driven time and the engine idling time in the rated time period. To avoid the influences through stops at traffic lights, only idling times greater than two minutes are considered. It will be apparent to those of ordinary skill in the art in view of the disclosure herein that other idling time limit values can similarly be used.

In the example embodiment, the Heavy Braking factor represents the brake usage rated with the help of a vehicle deceleration value, which can be derived from the vehicle speed. All brake activities between

$$3 \frac{m}{{s}^{2}} and 10 \frac{m}{{s}^{2}}$$

are measured and evaluated. For the final driver rating, the level of the deceleration results in the same amount of “error points” (e.g.,

$$3 \frac{m}{{s}^{2}}$$

equals 3 error points, etc.).

In the example embodiment, the Handbrake Usage while Driving factor evaluates all park brake usages with a vehicle speed greater than 3 km/h. It will be apparent to those of ordinary skill in the art in view of the disclosure herein that other vehicle speed limit values can similarly be used.

In the example embodiment, the Steady Driving factor evaluates the changes of the vehicle speed over the total driven time. Very high ratings are reached through a very constant vehicle speed. To reach a very high result for this factor, the vehicle speed must retain very constant levels. Frequent acceleration and deceleration decreases the value of this factor.

In the example embodiment, the Excessive Speed factor represents the relationship between total driven distance and distance driven with speeds greater than 85 km/h (52 mph). When accelerator pedal angle is near 0% (i.e., no throttle), excessive speed starts at speeds greater than 90 km/h (55 mph). It will be apparent to those of ordinary skill in the art in view of the disclosure herein that other vehicle speed limit values can similarly be used.

In the example embodiment, the Accelerator Position factor evaluates the changes of the accelerator pedal over the total driven time. Very high ratings are reached through a very constant usage of the accelerator pedal. If the driver switches very often between full throttle and no throttle, the rating decreases until it reaches 0%.

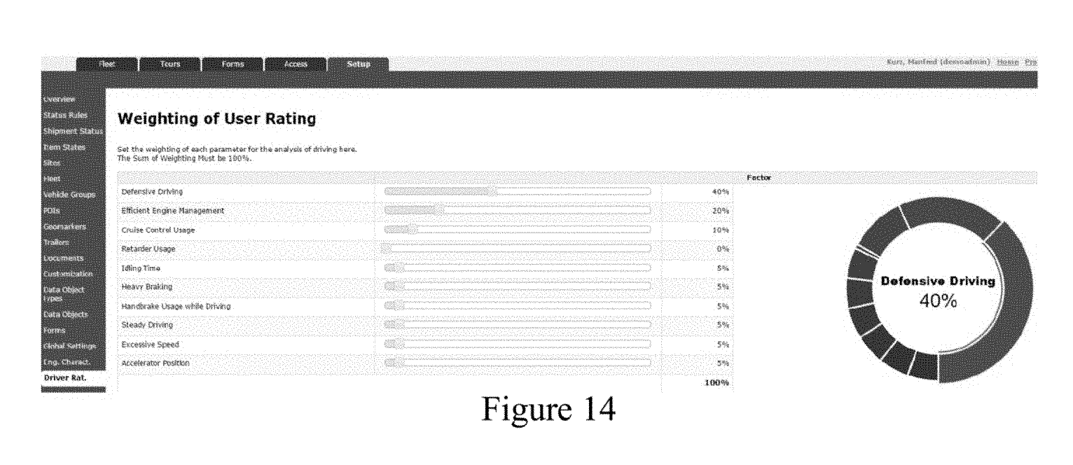

It will be apparent to those of ordinary skill in the art in view of the disclosure herein that a variety of other driving activities, behaviors, or characteristics of interest can be used in analyzing and rating the driving behavior of vehicle drivers. As described above, the telematics unit 110 can be locally or remotely updated and/or configured to add or modify the list of extensible characteristics, the set of preprocessing events, the degree of trip difficulty factors, and the factors used in generating the driver rating. Additionally, the example embodiment enables each of the factors in the driver scoring computation to be configurably weighted with a weighting value as shown in block 824. Each configurable weighting value allows the authorized client/user or a system administrator to configurably define a significance or priority of each factor. The configurable weighting factor can be considered a coefficient on the particular factor of the driver scoring computation. In one embodiment, a higher value weighting factor can correspond to a higher significance of the corresponding factor in the driver scoring computation. In an example embodiment, a set of parameter reference values can also be provided as shown in block 822. The parameter reference values can be used to establish a set of baseline values from which each of the factors can be based. As such, a set of average, expected, or desired reference parameters can be established for each of the factors in the driver scoring computation. As a result, the example embodiment can provide a highly configurable scoring of the behavior or activity of one of more drivers reporting activity via data blocks sent to the central server 120. Moreover, the configurable weighting factors used in the driver scoring computation can be viewed and readily configured by an authorized client/user or system administrator using a web-based or mobile device-based user interface. An example embodiment of such a user interface for viewing and configuring the configurable weighting factors used in the driver scoring computation is shown in FIG. 14. Changes in weighting factors can be immediately applied to all past and future visualized or calculated driver evaluations.

Given the RDS factors as detailed above, the example embodiment can calculate the RDS based on the weighted factors. The RDS can be generated as a combination, summation, or consolidation of the various RDS factors as detailed above. In the example embodiment, the RDS corresponds to the driver score generated without the application of the Degree of Trip Difficulty (DTD) bonus value as described above. In an example embodiment, the default RDS factor settings can be initially configured as shown in the table below:

| RDS Factors/Parameters | Default Factor Weight Settings |
|---|---|
| Defensive Driving | 30% |
| Efficient Engine Management | 30% |
| Cruise control usage | 10% |
| Retarder usage | 0% |
| Idling Time | 5% |
| Heavy Braking | 5% |
| Park brake usage | 5% |
| Steady Driving | 5% |
| Excessive Speed | 5% |
| Accelerator Position | 5% |
| Total | 100% |

Once the RDS is generated as detailed above, the example embodiment can calculate the DER as shown in block 826 of FIG. 8. In an example embodiment, the DER is based on a combination of the DTD and the RDS. In particular, the RDS can be generated and adjusted by the bonus value corresponding to the DTD as detailed above. As described above, the DTD can result in additional percentage points as a bonus value applied to the final driver rating. As shown in block 828 of FIG. 8, this bonus value can be determined from the DTD. Thus, in an example embodiment, the DER can be calculated in block 826 of FIG. 8 as follows:

Final Driver Rating(DER)=Raw Driver Score(RDS)+Bonus(a function of the DTD)

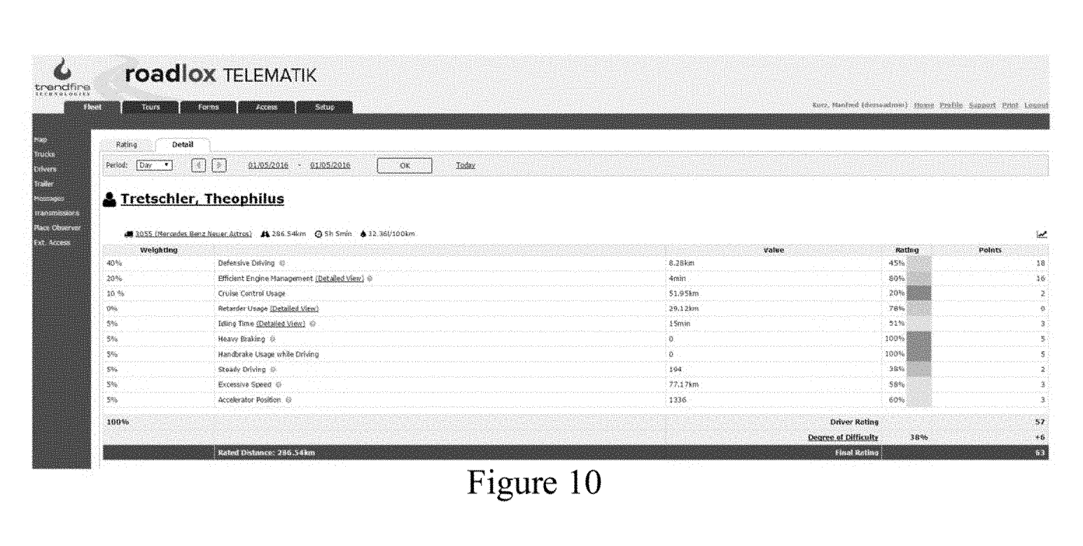

As shown in FIG. 8, the central server 120 can provide the Final Driver Rating (DER) to client/customers 140, mobile devices 130, or other network resources 150 (e.g., consumer nodes) via network 100. The Final Driver Rating (DER) and the associated driver evaluation information views can be generated and displayed on the consumer node devices via user interfaces, such as the user interfaces shown in the example embodiments of FIGS. 10 through 19.

In an alternative embodiment, the driver evaluation information as described above can be generated in real time on the telematics unit 110 in a condensed form that uses a fewer quantity of data blocks to reduce the computational load and data storage requirements on the telematics unit 110. For example, the telematics unit 110 can be configured to generate the condensed driver evaluation information in relation to a configurable time frame (e.g., 5, 10, 30 minutes, or other appropriate time period), which is typically a shorter time frame than the ranges of configurable time frames provided by the processing performed on the central server 120. This condensed driver evaluation information can be a basis for calculating a driver evaluation for a longer period of time (e.g., one day). This condensed driver evaluation information can also allow trip-specific driver evaluations over a shorter time frame. By providing a capability in the telematics unit 110 to generate the condensed driver evaluation information, the driver can have immediate access to the condensed driver evaluation information even if reliable network connectivity is not available. For example, real-time driver evaluation information can be provided to the driver in real-time using the direct mobile device interface connection 131 and displaying the real-time driver evaluation information to the driver on a user mobile device 130. This feature of an example embodiment is used for direct driving and driver feedback and continuous driver training while the driver is doing the daily work. Because this driver evaluation and feedback is performed in real time, no extra time for off-line driver training is necessary.

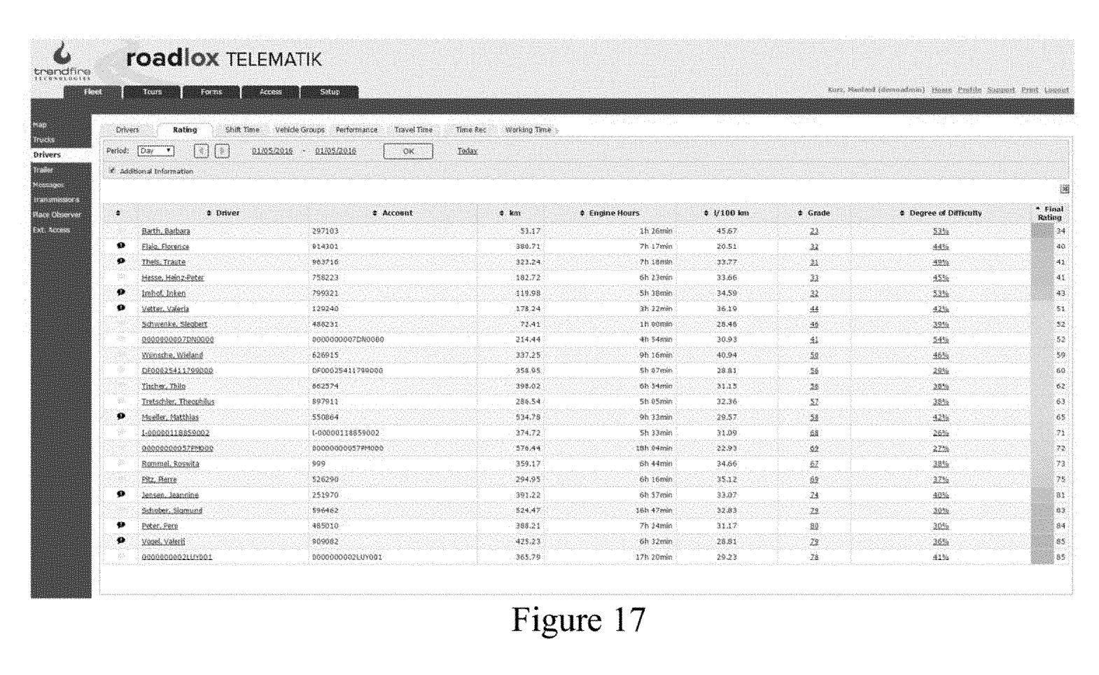

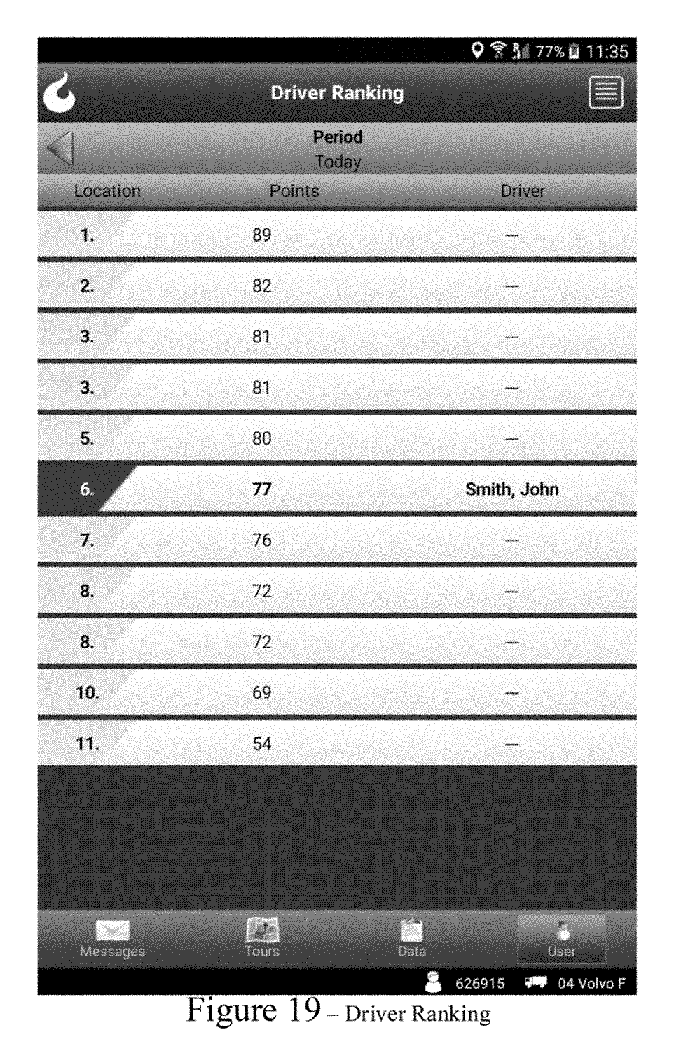

As described above, the various embodiments provide a capability for generating a plurality of current, real-time data blocks with information representing real-time events occurring in vehicle 112 and associated with a particular configurable timeframe, a particular vehicle location, a particular driver, and a particular vehicle. As also described above, this information is used to configurably score, rate, and evaluate drivers. This driver evaluation information can be used to evaluate and educate drivers, fleets, organizations, and industries about the behaviors and performance of a fleet of vehicles and their drivers. The driver evaluation information generated by the various embodiments described herein can be used to generate Driver Development Charts, which allow monitoring and driver evaluation over customizable time intervals. As a result, drivers and management are able to see their scores in real time, if the company permits, at any point in time. Driver evaluations for all of a company's drivers can be compared and summarized in a Company Score, which can show the quality of all drivers in a company or organization over time based on an aggregation of the DER values for the collection of drivers in the organization. The Company Score provides a comparative basis for customers to compare drivers, as well as creates a competitive index of the customers' drivers (e.g., see the examples in FIGS. 17 and 19). Drivers and management are able to see their relative position in comparison to other (identified or unidentified) drivers, if the company permits. Thus, the Driver Evaluation Rating (DER) and the related driver evaluation information generated by the various embodiments described herein can provide the basis for the implementation of performance-based compensation and bonus systems. The Driver Evaluation Rating (DER) and the related driver evaluation information can also be used to create an on-going skills improvement program to cause improvements in driver behaviors across companies, fleets, and industries.

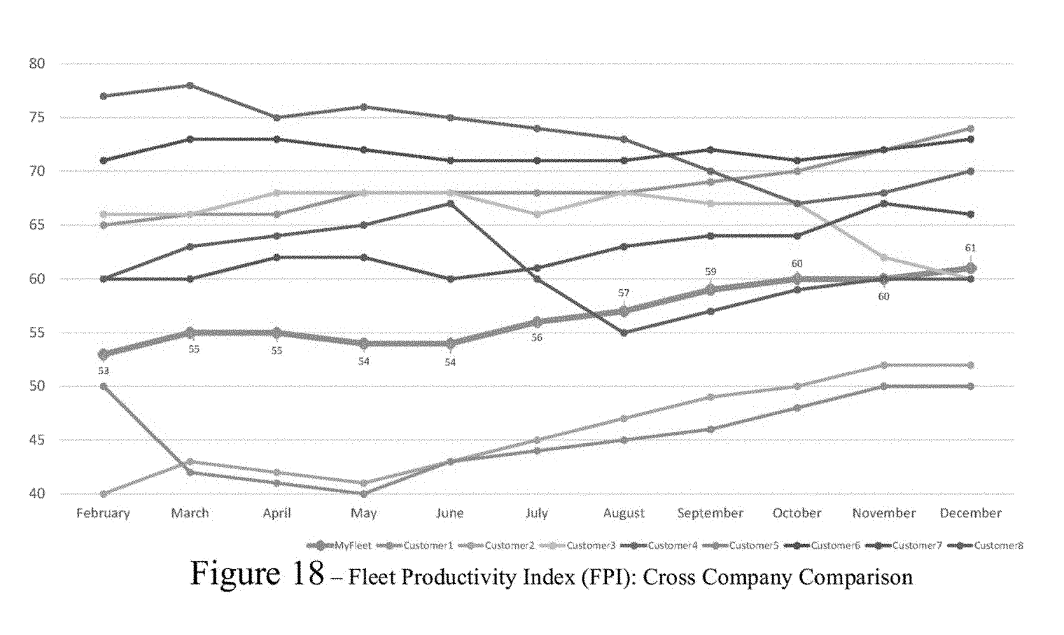

The example embodiments described herein include the generation of datasets and user interface views representing a cross-company comparison capability using the average of all driver ratings for a fleet as the basis for comparing various fleet characteristics, including productivity, to create a Fleet Index or Fleet Productivity Index (FPI). As example user interface view is shown in FIG. 18. The FPI can be based on a general weighting of driving factors/parameters and not on the client/customer specific configuration to keep the FPI consistent across fleets, and independent of any possible manipulation or customer specific adjustments. The FPI can be used for cross-company comparisons, internal company comparisons, cross-company subsidiary comparisons, cross-fleet sections or location comparisons, cross-market comparisons, cross-industry comparisons, cross-timeframe comparisons and the like. In the example embodiments, the FPI is beneficial for a variety of reasons including the following:
higher transportation earnings (less gasoline costs, less vehicle repairs, less accidents);
better insurance rates;
higher transportation fees from customers; and
improved driver safety and security.

In the example embodiments, the client/customer can determine the relative impact of each factor/parameter on the driver's score by using the weighting features as described herein. This feature of the example embodiments enables a customer organization to set its own prioritization of the factors/parameters for evaluating its drivers and fleet. That is, the client/customer organization can establish the importance, or priority, of each parameter to his/her business. The priority of each factor/parameter can be established by setting a weighting value associated with a particular driving behavior factor/parameter as described above. In one embodiment, the weighting value associated with each particular factor/parameter can be set using a slide bar object in the user interface. Examples are shown in FIG. 14. In this manner, the customer or user can set the priorities of particular driving behaviors based on the weighting values set for corresponding driving behavior factors/parameters. This prioritization of factors/parameters can make the customer's driver ratings unique to the customer organization. The prioritization of factors/parameters can also enable the customer organization to highlight and reward or punish particular driving behaviors or groups of driving behaviors. Additionally, an example embodiment can maintain both the “standard” (unweighted) data corresponding to each driver, as well as the customer-priority or customer-weighted version (weighted) factors/parameters, which allows the FPI to provide a normalized comparison on a consistent basis across companies, different customer organizations, or industries.

FIGS. 10 through 17 illustrate example user interface screen snapshots, implemented as a web application, that show the basic elements of the user interface for displaying data associated with the evaluation, rating, and skills improvement for a particular driver, in a particular vehicle, and on a particular date in an example embodiment.

FIG. 18 illustrates an example user interface screen snapshot, implemented as a web application, that shows the basic elements of the user interface for displaying data associated with the evaluation, rating, and skills improvement for a particular driver, in a particular vehicle, and on a particular date in an example embodiment, particularly, illustrating an example of a Fleet Productivity Index (FPI): Cross Company Comparison chart.

FIG. 19 illustrates an example user interface screen snapshot, implemented as a mobile device application, that shows the basic elements of the user interface for displaying data associated with the evaluation, rating, and skills improvement for a particular driver, in a particular vehicle, and on a particular date in an example embodiment, particularly, illustrating an example of a Driver Ranking view for a particular time period.

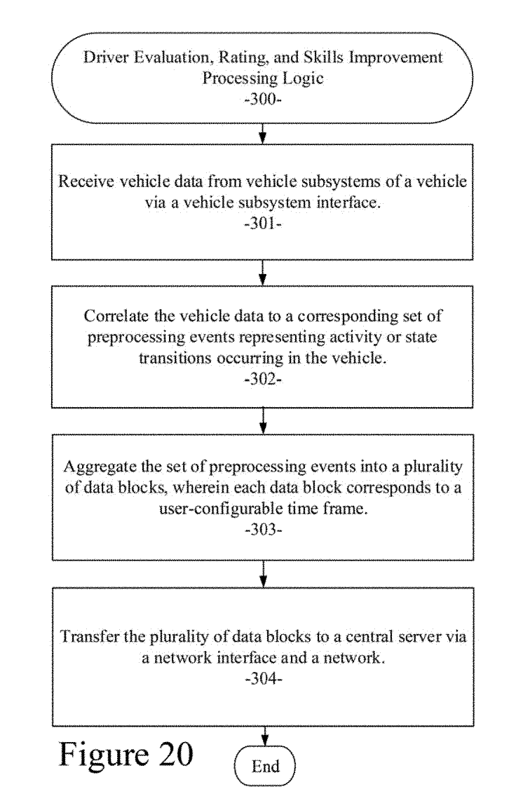

FIG. 20 is a processing flow diagram illustrating an example embodiment 300 of systems and methods for driver evaluation, rating, and skills improvement as described herein. The system and method of an example embodiment is configured to: receive vehicle data from vehicle subsystems of a vehicle via a vehicle subsystem interface (processing block 301); correlate the vehicle data to a corresponding set of preprocessing events representing activity or state transitions occurring in the vehicle (processing block 302); aggregate the set of preprocessing events into a plurality of data blocks, wherein each data block corresponds to a user-configurable time frame (processing block 303); and transfer the plurality of data blocks to a central server via a network interface and a network (processing block 304).

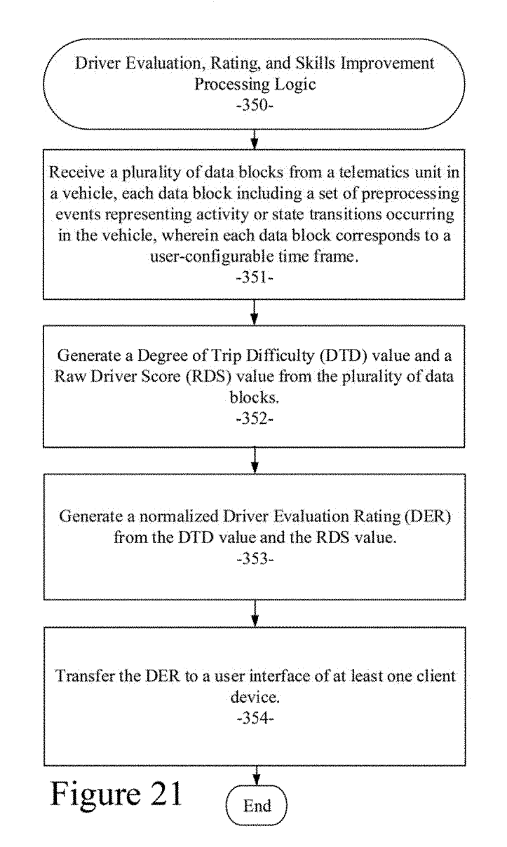

FIG. 21 is a processing flow diagram illustrating an example embodiment 350 of systems and methods for driver evaluation, rating, and skills improvement as described herein. The system and method of an example embodiment is configured to: receive a plurality of data blocks from a telematics unit in a vehicle, each data block including a set of preprocessing events representing activity or state transitions occurring in the vehicle, wherein each data block corresponds to a user-configurable time frame (processing block 351); generate a Degree of Trip Difficulty (DTD) value and a Raw Driver Score (RDS) value from the plurality of data blocks (processing block 352); generate a normalized Driver Evaluation Rating (DER) from the DTD value and the RDS value (processing block 353); and transfer the DER to a user interface of at least one client device (processing block 354).

Thus, systems and methods for driver evaluation, rating, and skills improvement are disclosed. Embodiments described herein are applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), SSD/NAND controller ASICs, and the like. In addition, in some of the drawings, signal conductor lines are represented with lines. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size can be manufactured. In addition, well-known power/ground connections to integrated circuit (IC) chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the platform within which the embodiment is to be implemented, i.e., such specifics should be well within purview of one of ordinary skill in the art. Where specific details (e.g., circuits) are set forth in order to describe example embodiments, it should be apparent to one of ordinary skill in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

Telematics unit 110 may include one or more wireless transceivers, in some embodiments. Each of the wireless transceivers may be implemented as physical wireless adapters or virtual wireless adapters, sometimes referred to as “hardware radios” and “software radios,” respectively. A single physical wireless adapter may be virtualized (e.g., using software) into multiple virtual wireless adapters. A physical wireless adapter typically connects to a hardware-based wireless access point. A virtual wireless adapter typically connects to a software-based wireless access point, sometimes referred to as a “SoftAP.” For instance, a virtual wireless adapter may allow ad hoc communications between peer devices, such as a smartphone and a desktop computer or notebook computer. Various embodiments may use a single physical wireless adapter implemented as multiple virtual wireless adapters, multiple physical wireless adapters, multiple physical wireless adapters each implemented as multiple virtual wireless adapters, or some combination thereof. The example embodiments described herein are not limited in this respect.

The wireless transceivers may include or implement various communication techniques to allow the telematics unit 110 to communicate with other electronic devices. For instance, the wireless transceivers may implement various types of standard communication elements designed to be interoperable with a network, such as one or more communications interfaces, network interfaces, network interface cards (NIC), radios, wireless transmitters/receivers (transceivers), wired and/or wireless communication media, physical connectors, and so forth.

By way of example, and not limitation, communication media includes wired communications media and wireless communications media. Examples of wired communications media may include a wire, cable, metal leads, printed circuit boards (PCB), backplanes, switch fabrics, semiconductor material, twisted-pair wire, co-axial cable, fiber optics, a propagated signal, and so forth. Examples of wireless communications media may include acoustic, radio-frequency (RF) spectrum, light (e.g., infrared and other parts of the spectrum), and other wireless media. Other embodiments can also use Li-Fi (Light Fidelity), which is a bidirectional, high speed and fully networked wireless optical communication technology similar to WiFi.

In various embodiments, the telematics unit 110 may implement different types of wireless transceivers. Each of the wireless transceivers may implement or utilize a same or different set of communication parameters to communicate information between various electronic devices. In one embodiment, for example, each of the wireless transceivers may implement or utilize a different set of communication parameters to communicate information between telematics unit 110 and any number of other devices. Some examples of communication parameters may include without limitation a communication protocol, a communication standard, a radio-frequency (RF) band, a radio, a transmitter/receiver (transceiver), a radio processor, a baseband processor, a network scanning threshold parameter, a radio-frequency channel parameter, an access point parameter, a rate selection parameter, a frame size parameter, an aggregation size parameter, a packet retry limit parameter, a protocol parameter, a radio parameter, modulation and coding scheme (MC S), acknowledgement parameter, media access control (MAC) layer parameter, physical (PHY) layer parameter, and any other communication parameters affecting operations for the wireless transceivers. The example embodiments described herein are not limited in this respect.

In various embodiments, the wireless transceivers may implement different communication parameters offering varying bandwidths, communications speeds, or transmission ranges. For instance, a first wireless transceiver may include a short-range interface implementing suitable communication parameters for shorter range communication of information, while a second wireless transceiver may include a long-range interface implementing suitable communication parameters for longer range communication of information.

In various embodiments, the terms “short-range” and “long-range” may be relative terms referring to associated communications ranges (or distances) for associated wireless transceivers as compared to each other rather than an objective standard. In one embodiment, for example, the term “short-range” may refer to a communications range or distance for the first wireless transceiver that is shorter than a communications range or distance for another wireless transceiver implemented for telematics unit 110, such as a second wireless transceiver. Similarly, the term “long-range” may refer to a communications range or distance for the second wireless transceiver that is longer than a communications range or distance for another wireless transceiver implemented for the telematics unit 110, such as the first wireless transceiver. The example embodiments described herein are not limited in this respect.

In one embodiment, for example, the wireless transceiver may include a radio designed to communicate information over a wireless personal area network (WPAN) or a wireless local area network (WLAN). The wireless transceiver may be arranged to provide data communications functionality in accordance with different types of lower range wireless network systems or protocols. Examples of suitable WPAN systems offering lower range data communication services may include a Bluetooth™ system as defined by the Bluetooth™ Special Interest Group, an infra-red (IR) system, an Institute of Electrical and Electronics Engineers (IEEE™) 802.15 system, a DASH7 system, wireless universal serial bus (USB), wireless high-definition (HD), an ultra-side band (UWB) system, and similar systems. Examples of suitable WLAN systems offering lower range data communications services may include the IEEE 802.xx series of protocols, such as the IEEE 802.11a/b/g/n series of standard protocols and variants (also referred to as “WiFi”). Other embodiments can also use Li-Fi (Light Fidelity), which is a bidirectional, high speed and fully networked wireless optical communication technology similar to WiFi. It may be appreciated that other wireless techniques may be implemented. The example embodiments described herein are not limited in this respect.

In one embodiment, for example, the wireless transceiver may include a radio designed to communicate information over a wireless metropolitan area network (WMAN), a wireless wide area network (WWAN), or a cellular radiotelephone system. Another wireless transceiver may be arranged to provide data communications functionality in accordance with different types of longer range wireless network systems or protocols. Examples of suitable wireless network systems offering longer range data communication services may include the IEEE 802.xx series of protocols, such as the IEEE 802.11a/b/g/n series of standard protocols and variants, the IEEE 802.16 series of standard protocols and variants, the IEEE 802.20 series of standard protocols and variants (also referred to as “Mobile Broadband Wireless Access”), and so forth. Alternatively, the wireless transceiver may include a radio designed to communicate information across data networking links provided by one or more cellular radiotelephone systems. Examples of cellular radiotelephone systems offering data communications services may include GSM with General Packet Radio Service (GPRS) systems (GSM/GPRS), CDMA/1×RTT systems, Enhanced Data Rates for Global Evolution (EDGE) systems, Evolution Data Only or Evolution Data Optimized (EV-DO) systems, Evolution For Data and Voice (EV-DV) systems, High Speed Downlink Packet Access (HSDPA) systems, High Speed Uplink Packet Access (HSUPA), and similar systems. It may be appreciated that other wireless techniques may be implemented. The example embodiments described herein are not limited in this respect.

Although not shown, telematics unit 110 may further include one or more device resources commonly implemented for electronic devices, such as various computing and communications platform hardware and software components typically implemented by a personal electronic device. Some examples of device resources may include without limitation a co-processor, a graphics processing unit (GPU), a chipset/platform control logic, an input/output (I/O) device, computer-readable media, network interfaces, portable power supplies (e.g., a battery), application programs, system programs, and so forth. The example embodiments described herein are not limited in this respect.

Included herein is a set of logic flows representative of example methodologies for performing novel aspects of the disclosed architecture. While, for purposes of simplicity of explanation, the one or more methodologies shown herein are shown and described as a series of acts, those of ordinary skill in the art will understand and appreciate that the methodologies are not limited by the order of acts. Some acts may, in accordance therewith, occur in a different order and/or concurrently with other acts from those shown and described herein. For example, those of ordinary skill in the art will understand and appreciate that a methodology can alternatively be represented as a series of interrelated states or events, such as in a state diagram. Moreover, not all acts illustrated in a methodology may be required for a novel implementation. A logic flow may be implemented in software, firmware, and/or hardware. In software and firmware embodiments, a logic flow may be implemented by computer executable instructions stored on at least one non-transitory computer readable medium or machine readable medium, such as an optical, magnetic or semiconductor storage. The example embodiments disclosed herein are not limited in this respect.

The various elements of the example embodiments as previously described with reference to the figures may include various hardware elements, software elements, or a combination of both. Examples of hardware elements may include devices, logic devices, components, processors, microprocessors, circuits, processors, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

The example embodiments described herein provide a technical solution to a technical problem. The various embodiments improve the functioning of the electronic device and the related system by providing a system and method for driver evaluation, rating, and skills improvement. The various embodiments also serve to transform the state of various system components based on a dynamically determined system context. Additionally, the various embodiments effect an improvement in a variety of technical fields including the fields of dynamic data processing, electronic systems, mobile devices, vehicle monitoring and control, data sensing systems, human/machine interfaces, mobile computing, information sharing, and mobile communications.

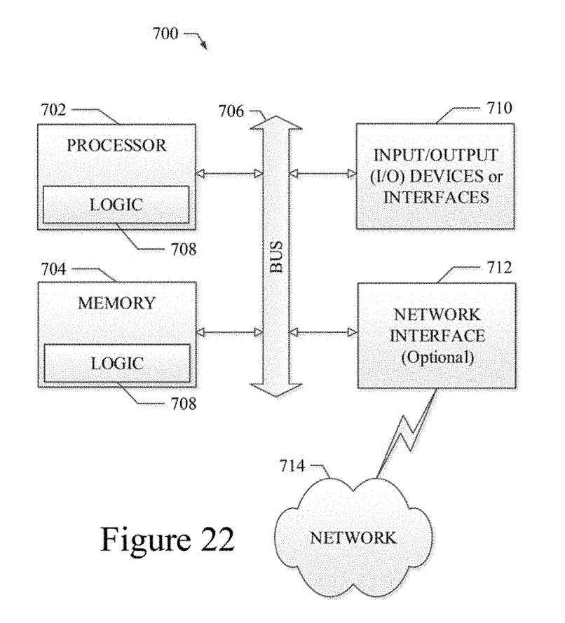

FIG. 22 shows a diagrammatic representation of a machine in the example form of an electronic device, such as a mobile computing and/or communication system 700 within which a set of instructions when executed and/or processing logic when activated may cause the machine to perform any one or more of the methodologies described and/or claimed herein. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a laptop computer, a tablet computing system, a Personal Digital Assistant (PDA), a cellular telephone, a smartphone, a web appliance, a set-top box (STB), a network router, switch or bridge, or any machine capable of executing a set of instructions (sequential or otherwise) or activating processing logic that specify actions to be taken by that machine. Further, while only a single machine is illustrated, the term “machine” can also be taken to include any collection of machines that individually or jointly execute a set (or multiple sets) of instructions or processing logic to perform any one or more of the methodologies described and/or claimed herein.

The example mobile computing and/or communication system 700 includes a data processor 702 (e.g., a System-on-a-Chip [SoC], general processing core, graphics core, and optionally other processing logic) and a memory 704, which can communicate with each other via a bus or other data transfer system 706. The mobile computing and/or communication system 700 may further include various input/output (I/O) devices and/or interfaces 710, such as a touchscreen display and optionally a network interface 712. In an example embodiment, the optional network interface 712 can include one or more radio transceivers configured for compatibility with any one or more standard wireless and/or cellular protocols or access technologies (e.g., 2nd (2G), 2.5, 3rd (3G), 4th (4G) generation, and future generation radio access for cellular systems, Global System for Mobile communication (GSM), General Packet Radio Services (GPRS), Enhanced Data GSM Environment (EDGE), Wideband Code Division Multiple Access (WCDMA), LTE, CDMA2000, WLAN, Wireless Router (WR) mesh, and the like). Network interface 712 may also be configured for use with various other wired and/or wireless communication protocols, including TCP/IP, UDP, SIP, SMS, RTP, WAP, CDMA, TDMA, UMTS, UWB, WiFi, WiMax, Bluetooth™, IEEE™ 802.11x, and the like. Other embodiments can also use Li-Fi (Light Fidelity), which is a bidirectional, high speed and fully networked wireless optical communication technology similar to WiFi. In essence, network interface 712 may include or support virtually any wired and/or wireless communication mechanisms by which information may travel between the mobile computing and/or communication system 700 and another computing or communication system via network 714.

The memory 704 can represent a machine-readable medium on which is stored one or more sets of instructions, software, firmware, or other processing logic (e.g., logic 708) embodying any one or more of the methodologies or functions described and/or claimed herein. The logic 708, or a portion thereof, may also reside, completely or at least partially within the processor 702 during execution thereof by the mobile computing and/or communication system 700. As such, the memory 704 and the processor 702 may also constitute machine-readable media. The logic 708, or a portion thereof, may also be configured as processing logic or logic, at least a portion of which is partially implemented in hardware. The logic 708, or a portion thereof, may further be transmitted or received over a network 714 via the network interface 712. While the machine-readable medium of an example embodiment can be a single medium, the term “machine-readable medium” should be taken to include a single non-transitory medium or multiple non-transitory media (e.g., a centralized or distributed database, and/or associated caches and computing systems) that store the one or more sets of instructions. The term “machine-readable medium” can also be taken to include any non-transitory medium that is capable of storing, encoding or carrying a set of instructions for execution by the machine and that cause the machine to perform any one or more of the methodologies of the various embodiments, or that is capable of storing, encoding or carrying data structures utilized by or associated with such a set of instructions. The term “machine-readable medium” can accordingly be taken to include, but not be limited to, solid-state memories, optical media, and magnetic media.

With general reference to notations and nomenclature used herein, the description presented herein may be disclosed in terms of program procedures executed on a computer or a network of computers. These procedural descriptions and representations may be used by those of ordinary skill in the art to convey their work to others of ordinary skill in the art.

A procedure is generally conceived to be a self-consistent sequence of operations performed on electrical, magnetic, or optical signals capable of being stored, transferred, combined, compared, and otherwise manipulated. These signals may be referred to as bits, values, elements, symbols, characters, terms, numbers, or the like. It should be noted, however, that all of these and similar terms are to be associated with the appropriate physical quantities and are merely convenient labels applied to those quantities. Further, the manipulations performed are often referred to in terms such as adding or comparing, which operations may be executed by one or more machines. Useful machines for performing operations of various embodiments may include general-purpose digital computers or similar devices. Various embodiments also relate to apparatus or systems for performing these operations. This apparatus may be specially constructed for a purpose, or it may include a general-purpose computer as selectively activated or reconfigured by a computer program stored in the computer. The procedures presented herein are not inherently related to a particular computer or other apparatus. Various general-purpose machines may be used with programs written in accordance with teachings herein, or it may prove convenient to construct more specialized apparatus to perform methods described herein.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

1. An in-vehicle telematics unit comprising:
one or more data processors;
a vehicle subsystem interface to connect the telematics unit with one or more vehicle subsystems of a vehicle;
a network interface to connect the telematics unit with a central server via a network; and
telematics unit processing logic, executable by the one or more data processors, to:
receive vehicle data from the vehicle subsystems via the vehicle subsystem interface;
correlate the vehicle data to a corresponding set of preprocessing events representing activity or state transitions occurring in the vehicle;
aggregate the set of preprocessing events into a plurality of data blocks, wherein each data block corresponds to a user-configurable time frame; and
transfer the plurality of data blocks to the central server via the network interface.

2. The in-vehicle telematics unit of claim 1 wherein the network is of a type from the group consisting of: the Internet, a cellular network, a satellite-based network, and a wireless network.

3. The in-vehicle telematics unit of claim 1 further including a mobile device interface to connect the telematics unit with one or more mobile devices.

4. The in-vehicle telematics unit of claim 1 wherein each of the data blocks includes driver identification credentials.

5. The in-vehicle telematics unit of claim 1 wherein at least one of the preprocessing events in the set of preprocessing events is of a type from the group consisting of: a defensive driving event, efficient engine management event, cruise control usage event, retarder usage event, idling time event, heavy braking event, handbrake usage event, steady driving event, excessive speed event, and an accelerator position event.

6. The in-vehicle telematics unit of claim 1 wherein each of the data blocks are generated in real time.

7. The in-vehicle telematics unit of claim 1 being further configured to generate condensed driver evaluation information in relation to a configurable time frame based on the set of preprocessing events.

8. A central server comprising:
one or more data processors;
a network interface to connect the central server with a telematics unit in a vehicle and at least one client device via a network; and
server processing logic, executable by the one or more data processors, to:
receive a plurality of data blocks from the telematics unit, each data block including a set of preprocessing events representing activity or state transitions occurring in the vehicle, wherein each data block corresponds to a user-configurable time frame;
generate a Degree of Trip Difficulty (DTD) value and a Raw Driver Score (RDS) value from the plurality of data blocks;
generate a normalized Driver Evaluation Rating (DER) from the DTD value and the RDS value; and
transfer the DER to a user interface of the at least one client device.

9. The central server of claim 8 wherein the network is of a type from the group consisting of: the Internet, a cellular network, a satellite-based network, and a wireless network.

10. The central server of claim 8 further including a mobile device interface to connect the central server with one or more mobile devices.

11. The central server of claim 8 wherein each of the data blocks includes driver identification credentials.

12. The central server of claim 8 wherein at least one of the preprocessing events in the set of preprocessing events is of a type from the group consisting of: a defensive driving event, efficient engine management event, cruise control usage event, retarder usage event, idling time event, heavy braking event, handbrake usage event, steady driving event, excessive speed event, and an accelerator position event.

13. The central server of claim 8 wherein each of the data blocks are generated in real time.

14. The central server of claim 8 wherein the DTD value and the RDS value are generated using weighted factors.

15. A non-transitory machine-useable storage medium embodying instructions which, when executed by a machine, cause the machine to:
receive vehicle data from vehicle subsystems of a vehicle via a vehicle subsystem interface;
correlate the vehicle data to a corresponding set of preprocessing events representing activity or state transitions occurring in the vehicle;
aggregate the set of preprocessing events into a plurality of data blocks, wherein each data block corresponds to a user-configurable time frame; and
transfer the plurality of data blocks to a central server via a network interface and a network.

16. The machine-useable storage medium of claim 15 wherein the network is of a type from the group consisting of: the Internet, a cellular network, a satellite-based network, and a wireless network.

17. The machine-useable storage medium of claim 15 further including a mobile device interface to connect with one or more mobile devices.

18. The machine-useable storage medium of claim 15 wherein each of the data blocks includes driver identification credentials.

19. The machine-useable storage medium of claim 15 wherein at least one of the preprocessing events in the set of preprocessing events is of a type from the group consisting of: a defensive driving event, efficient engine management event, cruise control usage event, retarder usage event, idling time event, heavy braking event, handbrake usage event, steady driving event, excessive speed event, and an accelerator position event.

20. The machine-useable storage medium of claim 15 wherein each of the data blocks are generated in real time.
